(19) United States
(12) Patent Application Publication
(10) Pub. No.: US 2021/0071043 A1
(43) Pub. Date: Mar. 11, 2021

(54) POSITIONABLE AND REPOSITIONABLE ADHESIVE ARTICLES FOR STRETCH RELEASE REMOVAL

(71) Applicant: 3M INNOVATIVE PROPERTIES COMPANY, St. Paul, MN (US)

(72) Inventors: Payam Khodaparast, Minneapolis, MN (US); Nishant C. Kumar, St. Paul, MN (US); Joseph A. Hoffman, Minneapolis, MN (US); Margaret M. Sheridan, Woodbury, MN (US); Guy M. Kallman, Woodbury, MN (US); Sara Hemmer Frisco, Blaine, MN (US); Nicholas A. Lee, Woodbury, MN (US); Ann M. Gilman, Bayport, MN (US); Matthew R. D. Smith, Woodbury, MN (US)

(21) Appl. No.: 17/054,668

(22) PCT Filed: May 8, 2019
(86) PCT No.: PCT/US2019/031339

§ 371 Date: Nov. 11, 2020

Related U.S. Application Data
(60) Provisional application No. 62/670,511, filed on May 11, 2018.

(51) Int. Cl. C09J 7/40; B32B 27/06; B32B 27/08; B32B 3/10; C09J 7/38

(52) U.S. Cl. CPC C09J 7/403; B32B 27/065; A47G 1/175; B32B 3/10; C09J 7/381; B32B 27/08

(57) ABSTRACT

The present disclosure relates to adhesive article that include a stretch releasable adhesive and topographical, engineered elements on, within, or partially embedded in a surface of the adhesive. The engineered elements can act as spacers between the adhesive surface and the mounting surface to prevent full contact and wet out of the adhesive, whereby the article can be initially positioned or rotated by sliding the surface of the projections across the wall surface. Under certain conditions, the article may even be removed from the wall and placed at a new location without damage to the wall surface or the article. Once the location is selected, the separation created by the engineered elements can be overcome by applying sufficient pressure; the adhesive can contact and adhere more permanently to the wall. Thus, a stretch releasable adhesive articles of the present disclosure can move freely against the desired mounting surface, develop additional tack and holding power after sufficient pressure is applied.

### BACKGROUND

The revolutionary Command® Adhesive Strip products are a line of stretch releasable adhesive strips that holds strongly on a variety of surfaces (including paint, wood, and tile) and that remove cleanly—no holes, marks, or sticky residue. In general, these products include a stretch release pressure sensitive adhesive composition disposed on tape or other backings and generally have utility in bonding to various surfaces or substrates for numerous applications. Stretch-release products are designed to firmly adhere an article, such as a hook (to hold a picture or an article of clothing) or other decorative or utilitarian element, to a surface (an adherend), yet remove cleanly when pulled away from the surface at a low angle. The clean removal aspect is so that a tacky and/or unsightly residue is not left behind on the surface after removal of the stretch release adhesive. During the process of stretch release removal, the adhesive layer preferably remains adhered to the tape backing as the backing is stretched, but releases from the surface (adherend).

Stretch releasable adhesives that can be removed from a surface by stretching are known in the patented prior art. U.S. Pat. No. 5,516,581 (Kreckel et al.) discloses a removable adhesive tape having a highly extensible and substantially inelastic backing coated with a layer of pressure sensitive adhesive. U.S. Pat. No. 6,231,962 (Bries et al.) discloses conformable pressure-sensitive adhesive tapes which comprise a layer of polymeric foam in the backing and may be adhered firmly to a substrate and thereafter removed therefrom by stretching at an angle no greater than about 35° from the surface of the substrate. U.S. Pat. No. 7,078,093 (Sheridan et al.) discloses a stretch releasing pressure sensitive adhesive tape including a silicone pressure sensitive adhesive composition that exhibits a 180° peel strength on a glass substrate at 98% relative humidity of at least about 5.47 N/dm, and a non-tacky tab. U.S. Pat. No. 6,395,389 (Lühmann et al.) discloses an adhesive tape strip for a rereleasable adhesive bond, which can be removed from a bonded joint by pulling in the direction of the bond plane, having a non-adhesive grip tab and a subsequent, elongate strip which is adhesive on one or both sides.

### SUMMARY

The inventors of the present disclosure recognized that the existing mounting products suffered from various disadvantages. Existing mounting products seldom allow for a user to adjust location or orientation, even slightly, once the exposed adhesive is placed in contact with the desired mounting surface. The adhesives commonly used in these products, particularly those designed for damage free, stretch release removal, demonstrate high initial tack or “quick stick” behavior, resulting in a rapid setting bond with the wall or other mounting surface

Although several methods and configurations have been developed to make application of mounting articles easier, no solution to date provides for mounting articles capable of forming strong bonds that have a combination of low-stick positioning, rapid bonding when pressed in place and retention of high shear strength allowing for damage free mounting of larger articles.

The inventors of the present disclosure sought to formulate mounting products and/or adhesive articles that combine an ability to initially adjust the position of an adhesive article with an acceptable shear strength suitable for holding large or heavy objects, all while avoiding damage to the mounting surface during initial application, positioning, use, and removal.

In accordance with the present disclosure, an adhesive article is provided which includes a stretch releasable adhesive and topographical, engineered elements on, within, or partially embedded in a surface of the adhesive. The engineered elements can act as spacers between the adhesive surface and the mounting surface to prevent full contact and wet out of the adhesive, whereby the article can be initially positioned or rotated by sliding the surface of the projections across the wall surface. Under certain conditions, the article may even be removed from the wall and placed at a new location. Once the location is selected, the separation created by the engineered elements can be overcome by applying sufficient pressure; the adhesive can contact and adhere to the wall. Thus, a stretch releasable adhesive article is provided which can slide freely against the desired mounting surface and which develops additional tack after pressure is applied.

The surface features on a stretch releasable adhesive surface provides a unique combination of properties an adhesive article that may be easily positioned on a substrate surface, optionally, it may be weakly and temporally bonded to the substrate and repositioned as desired, then attached to the surface of the substrate with a stronger bond by applying firm pressure. Advantageously, the present disclosure provides an adhesive article that may be removed after application, all the while retaining ease of initial positioning and rapid, more permanent attachment once firm pressure is applied.

In some embodiments, the engineered elements define between about 10% and about 90% percent of a total adhesive article area. In some embodiments, the engineered elements collectively define between about 10% and about 45% percent of a total adhesive article area. In some embodiments, the engineered elements collectively define between about 15% and about 35% of a total adhesive area. In some embodiments, the adhesive region (i.e., areas of adhesive which to do not feature engineered elements) comprises between about 10% and about 90% area percent of a total adhesive surface area. In some embodiments, the adhesive region comprises between about 20% and about 80% percent of a total adhesive surface area.

In some embodiments, the engineered element includes a non-adhesive element including a deadening layer that reduces or eliminates the adhesion of an adhesive underlying the deadening layer.

In some embodiments, the engineered element includes a discrete adhesive or composite peg.

In some embodiments, the engineered element includes a particle or collection of particles.

In some embodiments, the engineered elements include one or more intrusive features. The intrusive features typically include a plurality of channels in the surface of an adhesive. In some embodiments, the engineered elements include a combination of channels, particles, pegs, and/or deadening material.

As used herein, “positionable” means an adhesive article that can be placed against a substrate surface and easily slid over the surface into proper position without preadhering or sticking the adhesive article to the substrate; pressure is generally required to adhere the adhesive article to the substrate.

As used herein, “repositionable” means an adhesive article that can be applied to a substrate and then removed and reapplied without distorting, defacing, or destroying the adhesive article, or substrate; repositionable adhesives need not be positionable or vice versa.

As used herein, “repositionable holding” means a repositionable article that can be reapplied to a substrate and will thereafter hold at least 3 pounds according to the Repositionable Holding test.

As used herein, “tack” means the instant contact adhesion between the adhesive and the substrate.

As used herein, an “engineered element”, “engineered feature” and “engineered structure” are used interchangeably mean a structure deliberately applied to or created from an adhesive surface.

As used herein “geometry” refers to the size and shape of an engineered element.

As used herein, the term “pitch” identifies the distance between the centroids of adjacent adhesive or non-adhesive features or regions. The pitch is measured from the centroid of a feature or region (i.e., the geometric center) to the centroid of an adjacent feature or region of like adhesive (or non-adhesive) character.

As used herein, “layer” means a single stratum that may be continuous or discontinuous over a surface.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As recited herein, all numbers should be considered modified by the term “about”.

As used herein, “a”, “an”, “the”, “at least one”, and “one or more” are used interchangeably. Thus, for example, an engineered surface comprising “a” pattern of recesses can be interpreted as an engineered surface comprising “one or more” patterns.

Also, the recitations herein of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The disclosure will be further described with reference to the drawings, wherein corresponding reference characters indicate corresponding parts throughout the several views, and wherein:

FIG. 1 illustrates an arrangement of engineered structures on the surface of an adhesive construction, according to one embodiment of the present disclosure;

FIG. 2 illustrates an arrangement of engineered structures on the surface of an adhesive construction, according to one embodiment of the present disclosure;

FIG. 3 is a schematic side-view of an engineered structure according to another embodiment;

FIG. 4 is schematic side-view of an engineered structure according to another embodiment of the present disclosure;

FIG. 5 is an illustration of engineered elements on the surface of an adhesive construction according to another embodiment of the present disclosure;

FIG. 6a is a segmented planar view of a surface with intrusive channel features according to another embodiment of the present disclosure; and

FIG. 6b is a segmented view of an adhesive article highlighting the channel features of FIG. 6a.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

Characteristically, the adhesive articles of the present disclosure include a stretch releasable adhesive layer and at least one structured surface having topographical, engineered structures or elements, such that the article demonstrates at least two levels of adhesion: a contact bond defined by low initial tack and an application bond. The initial contact bond is substantially less than the application bond and the contact bond can be changed to the application bond with the application of pressure. The engineered structures thus permit the article to either slide over the surface of a substrate, or be easily removed from the surface of the substrate, until enough pressure is applied to enable a bond between the adhesive and the surface of the substrate.

The adhesive articles of the present disclosure can be positionable, repositionable, or both. In some advantageous embodiments, the adhesive articles demonstrate repositionable holding, in that the article does not substantially lose shear strength when holding a mounting object on a vertical substrate after the article has been initially adhered, removed, and re-adhered to the substrate

The adhesive articles of the present disclosure can include protrusive engineered structures such as projecting adhesive “pegs” or “posts”, discrete, partially embedded particles, discrete projecting clusters of particles, non-adhesive islands including a deadening material, and combinations thereof. These elements are at least partially protrusive from the adhesive surface. Protrusive elements represent a departure or deviation away from the average elevation of an otherwise planar surface region.

In some embodiments, the topographical features are distributed as a periodic array across a structured surface region (e.g., a one-dimensional array or a two-dimensional array, for example a square array, hexagonal, or other regular array). In some embodiments, the structured surface includes an arranged pattern of elements. An “arranged pattern” is a plurality of engineered features arranged at predetermined positions, arranged with some degree of regularity, or arranged in any desired manner. For example, the arranged pattern can include an arranged row pattern, an arranged lattice pattern such as an arranged square lattice pattern, an arranged zigzag pattern, or an arranged radial pattern. The arranged pattern need not be formed evenly on the entire surface but may be formed in only a portion of the article surface. The pattern may vary or remain the same over any portion of the article. For example, similar or different patterns can be used within the same plane. The elements within the pattern can be of similar size and shape or can have different sizes and shapes.

In some embodiments, engineered elements can be present on a regular repeating basis, on a random basis, or combinations thereof. In other embodiments, the elements can be present over a portion of the entire area of the adhesive region, or present over the entire area of the adhesive region. The elements may also in some cases be closely packed, i.e., arranged such that at least portions of boundaries of many or most adjacent elements substantially meet, coincide, of substantially overlap. The structures can be irregularly or non-uniformly dispersed on the adhesive surface.

Advantageously, the creation of structures according to the methods and concepts herein eliminates or substantially reduces any deleterious effect on the mechanical performance of the adhesive construction or an article containing the adhesive construction.

Certain engineered structures of the present disclosure are non-adhesive. The non-adhesive elements of the present disclosure lack significant or any adhesive properties, and thus created non-adhesive regions on the affected surface of the adhesive articles. As used herein, the term “non-adhesive region” refers to one or more regions of the adhesive article having a reduction in adhesive properties (peel adhesion or tack) as compared to the adhesive region(s) ranging from about 90% to about 100% as measured by ASTM D3330/3330M-04 (for peel adhesion) and/or ASTM D2979-01 (2009) (probe tack). In presently preferred implementations, the non-adhesive region article has a reduction in adhesive properties (peel adhesion or tack) as compared to the adhesive region(s) ranging from about 95% to about 100%; in other implementations, particularly those suitable for use with at least one of delicate and textured surfaces, the non-adhesive region(s) have a reduction in adhesive properties (peel adhesion or tack) as compared to an adhesive region(s) of at least about 99%.

The adhesive article embodiments exemplified herein provide excellent adhesion and shear holding power during use as well as damage-free removal from the wall, surface, or substrate to which the adhesive article is adhered, mounted, or attached. The stretch releasable articles herein can include a single or multilayer construction that can be removed from a substrate or surface by stretching it at an angle of less than 35°.

The present disclosure generally relates to adhesive articles that can be removed from a substrate without damage. As used herein, the terms “without damage” and “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

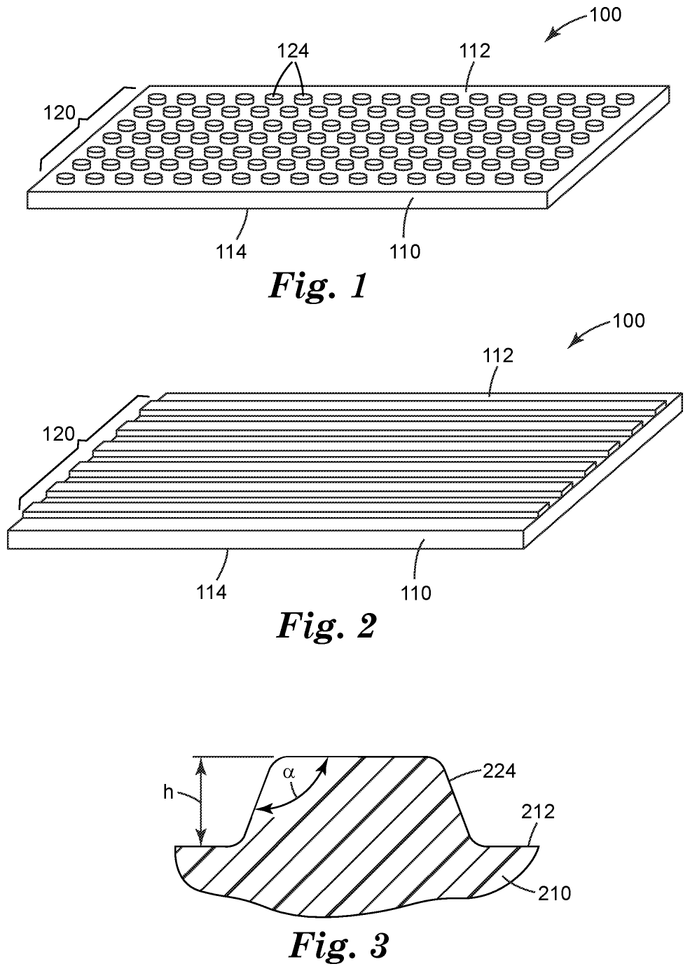

An adhesive article featuring a structured surface of non-adhesive, engineered elements is depicted in FIGS. 1 and 2. Adhesive article 100 includes an adhesive construction 110 including first and second opposed major surfaces 112 and 114. A mounting device (not shown) can be disposed adjacent the second major surface 114 of the adhesive construction 110. The first major surface 112 provides an available adhesive region for securing the article to the desired mounting surface.

The adhesive construction 110 may include a backing or may be backing free. Backing free adhesive constructions are described, for example, in US Publication No. 2016/0068722 (Schmitz-Stapela et al.). The adhesive construction 110 may include one or more adhesive layers disposed on a backing. An adhesive layer may be disposed on a backing to provide the first adhesive surface 112. The second major surface 114 may include an additional adhesive layer or may lack significant adhesive functionality. Each adhesive layer may be single layer or multilayer. The backing may likewise be single layer or multilayer. Adhesive layers can be the same as one another or disparate from one another. Disparate, in this context, is used to describe substantial differences in composition or adhesive performance. Adhesive layers can each be continuous or discontinuous (e.g., patterned) across the major surfaces of the backing.

The first major surface 112 includes a non-adhesive region 120 defined by a plurality of non-adhesive elements 124. The adhesive region 120 as depicted includes an arranged pattern of discrete non-adhesive elements or islands 124. The non-adhesive elements 124 are arranged in a hexagonal array, but other patterns and arrangements are possible, including unstructured arrays. In some embodiments, the patterns resemble or are a tessellation. In some embodiments, the non-adhesive elements 124 are distributed as a periodic array across a surface (e.g., a one-dimensional array or a two-dimensional array, for example a square array, hexagonal, or other regular array). For example, the arranged pattern of can include an arranged row pattern, an arranged lattice pattern such as an arranged square lattice pattern, an arranged zigzag pattern, an arranged radial pattern, and combinations thereof. The arranged pattern need not be formed evenly on the entire surface but may be formed in only a portion of the adhesive surface 112. The pattern of non-adhesive elements may vary or remain the same over any portion of the article. For example, similar or different patterns can be used across the adhesive surface 112. The features within the pattern can be of similar geometry or can have different geometries.

Each non-adhesive element 124 includes a deadening material, which decreases or eliminates the adhesiveness of the underlying adhesive layer. Exemplary deadening materials include, for example, glass bubbles (as further described below), a film, a clear ink, a liquor, and/or an adhesive with significantly lower adhesion properties. In presently preferred implementations, the deadening material comprises an ink and/or an ink including fumed silica. In some embodiments, the deadening material has a thickness of between about 1 nm and about 1000 microns. In some embodiments, the deadening material has a thickness of between about 1 nm and about 100 microns. In some embodiments, the deadening material has a thickness of between about 100 nm and about 50 microns. The deadening material thickness is typically selected so that the non-adhesive elements 124 provide sufficient space between the mounting surface and the adhesive layer on initial contact, but do not prevent the adhesive from wetting out and forming a stronger bond on application of adequate pressure. Accordingly, the thickness of the deadening material is typically no greater than 4 times the thickness of the adhesive construction.

The non-adhesive elements 124 can take the form of any shape. The illustrated embodiment of first major surface 112 comprises a plurality of circular islands 124. Other, non-limiting examples of cross-sectional shapes that are suitable for non-adhesive elements 124 include parallelograms, parallelograms with rounded corners, rectangles, squares, circles, half-circles, ellipses, half-ellipses, triangles, trapezoids, stars, ovals, teardrops, other polygons (e.g., hexagons), etc., and combinations thereof. Each element includes a largest cross-sectional dimension. The size of the largest cross-sectional dimension is not particularly limited but is typically at least 75 microns.

Additional suitable element shapes include irregular geometries that can be described by non-Euclidean mathematics. Non-Euclidean mathematics is generally used to describe those features whose mass is directly proportional to a characteristic dimension of the spaced feature raised to a fractional power (e.g., fractional powers such as 1.34, 2.75, 3.53, or the like). Examples of geometries that can be described by non-Euclidean mathematics include fractals and other irregularly shaped elements. For irregularly shaped features (e.g., features which are not parallelograms, regular polygons, or circles) the largest cross-sectional dimension will be understood to be the diameter of a circle of equivalent area.

A Cartesian x-y-z coordinate system is included in FIGS. 1 and 2 for reference purposes. The first and second major surfaces 112, 114 of the adhesive construction 110 extend generally parallel to the x-y plane, and the thickness of the adhesive construction 110 corresponds to the z-axis. The array of non-adhesive islands 124 includes a transverse direction, generally along the x-axis and a longitudinal direction, generally along the y-axis. The arranged pattern includes a defined spacing or pitch between nearest-neighboring, adjacent non-adhesive islands 124. The pitch between adjacent islands 124 in an array or pattern may be the same in both the transverse direction and longitudinal direction. In other embodiments, the pitch along the transverse direction is less than the pitch along the longitudinal direction, and vice versa. In exemplary embodiments, the pitch is between about 80 microns and about 210 microns.

As depicted in FIG. 1, the islands 124 are discrete along both the transverse and longitudinal directions of the first major surface 112. In other embodiments and as demonstrated partially in FIG. 2, the non-adhesive elements can be discrete along one direction, such that the elements resemble ridges or stripes (see FIG. 2), or may extend diagonally (relative to the orientation shown in e.g., FIG. 1) across the major surface 112 of the adhesive construction. Such ridges can follow any desired path and can be continuous or discontinuous across a surface in any given direction.

The non-adhesive region 120 includes a plurality of islands 124 each having substantially the same geometry. In other embodiments, the size or shape of the islands 124 may change across the transverse direction, longitudinal direction, or combinations thereof. In yet other embodiments, the non-adhesive region 120 can include two or more elements or islands 124 of different geometries arranged in repeating unit cell. The unit cell can be repeated in an arranged pattern of unit cells. A variety of shapes may be used to define the unit cell, including rectangles, circles, half-circles, ellipses, half-ellipses, triangles, trapezoids, and other polygons (e.g., pentagons, hexagons, octagons), etc., and combinations thereof. In such embodiments, each unit cell boundary is directly adjacent the boundary of a neighboring unit cell, so that the plurality of unit cells resembles, e.g., a grid or tessellation.

As discussed above and seen in e.g., FIGS. 1 and 2, the non-adhesive islands 124 are discreet, resulting in interstitial spaces 126 between any two adjacent islands 124. The interstitial spaces 126 possess adhesive functionality. Accordingly, the sum area of the interstitial spaces 126 defines the adhesive region on the first major surface 112. In presently preferred implementations, the islands 124 are not closely packed, such that the boundaries of any individual island 124 are not directly adjacent, coincident, or overlapping the boundaries of any adjacent island 124. This provides sufficient interstitial space to realize the damage reduction, at least positionability, and other benefits extolled below.

For any of the arranged distributions of non-adhesive elements described herein, the area of the adhesive surface including the plurality of non-adhesive elements is typically smaller than the area bound within interstitial spaces 126. In some embodiments, no greater than 50% of the area of is contained within the non-adhesive elements, in some embodiments no greater than 45% of the area, in some embodiments no greater than 40%, in some embodiments no greater than 35%, in some embodiments no greater than 30%, in some embodiments no greater than 20%, in some embodiments no greater than 15%, and in yet additional embodiments no greater than 10% of the area is contained within the non-adhesive elements 124. In certain circumstances, a non-adhesive region exceeding 50% of the total area may detract from the shear strength of the adhesive article or interfere with establishing an application bond. If repositionability or repositionable holding behavior is desired, it can be useful, in some circumstances, to maintain the surface area contained within the non-adhesive elements to at least 15% and no greater than 30% of the total area, and in some embodiments no greater than 25%.

The arranged pattern may result in a particular density of non-adhesive elements 124 per square inch (i.e., dots per inch square or DPI). In some implementations, the first surface 112 comprises no greater than 5000 elements per square inch, in some embodiments no greater than 4000, in some embodiments no greater than 3000, in some embodiments no greater than 2500, in some embodiments no greater than 2000, in some embodiments no greater than 1500, in some embodiments no greater than 500, in some embodiments no greater than 300, and, in other embodiments no greater than 200 elements per square inch. Without wishing to be bound by theory, greater density of the non-adhesive elements is correlated with compromised shear performance of the adhesive article but can aid in both positionability and repositionability (depending on at least non-adhesive surface area).

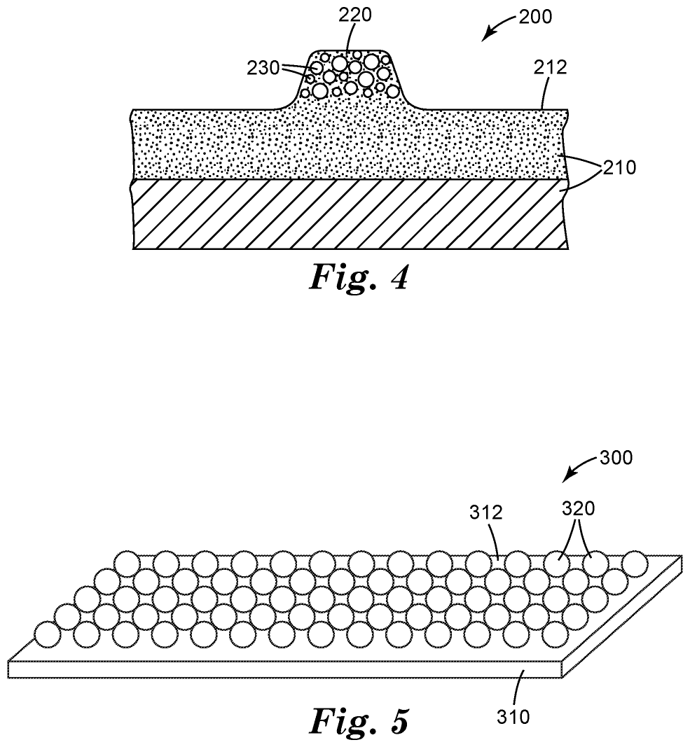

Another embodiment of a positionable, stretch releasable adhesive article is depicted in FIGS. 3 and 4. An adhesive article 200 has an adhesive construction 210 and at least one surface including engineered surface elements 220. Alternatively, the adhesive construction 210 may be configured in such a way as to have two engineered surfaces, with or without a backing. Surface features suitable as engineered surface elements include but are not limited to the discrete adhesive and composite “pegs” described by U.S. Pat. No. 5,296,277 (Wilson et al.) and U.S. Pat. No. 5,795,636 (Keller et al.).

In the embodiment of FIGS. 3 and 4, the engineered element 220 is a projecting “peg” or “post” (both are used interchangeably herein). The pegs may be adhesive, particle-filled adhesive or nonadhesive. The peg 220 may have adhesive tops or nonadhesive tops (provided by means of a nonadhesive cap, for example), and may or may not contain or be covered with particles that may or may not be adhesive, such as non-tacky microspheres. The pegs generally comprise the same adhesive material as the underlying adhesive surface of the adhesive construction 210. The pegs have substantially flat tops that generally have a contact area of 1-25% of the total planar adhesive area made available by major surface 212. In presently preferred implementations, the contact area of the adhesive structures is between about 6% and about 17% of the total planar adhesive surface area.

Engineered pegs 220 can be shaped such that the cross section of a peg taken in a plane parallel to the adhesive layer may be oval, circular, polygonal, rectangular, star-shaped, annular, irregular, and any combination thereof. The inside angle (a) between the top and the sides of a peg is typically no greater than 150°, more typically between 80° and 135°.

With reference to FIG. 4, an adhesive construction 210 has a structured adhesive surface, wherein the structured adhesive surface comprises a distribution of composite pegs 220, protruding from the adhesive surface 212. Pegs 220 are a composite of adhesive and particles 230, with particles 230 being substantially covered by adhesive within the peg. While particles 230 can be completely covered or encompassed by adhesive, it is contemplated that a small portion of the particles may be above or below the surface and not covered by the adhesive. Although FIG. 4 illustrates peg 220 as being filled with particles 230, it is also possible to have pegs that are only partially filled with particles or to include some or all pegs in a given distribution that are not filled with particles.

The distribution of engineered elements 220 (e.g., pegs) typically includes a defined spacing or pitch between nearest-neighboring, adjacent elements. The pitch may be the same in both the transverse direction and longitudinal direction. In other embodiments, the pitch along the transverse direction is less than the pitch along the longitudinal direction, and vice versa. In exemplary embodiments, the pitch is between about 100 microns and about 300 microns, or more particularly between about 150 microns and about 200 microns.

In embodiments of the present disclosure featuring pegs as engineered structures, typically no greater than 25% of the area of is contained within the adhesive elements, in some embodiments no greater than 20% of the area, in some embodiments no greater than 15%, in some embodiments no greater than 10%, in some embodiments no greater than 8%, in some embodiments no greater than 6%, in some embodiments no greater than 5%, and the total planar area of the adhesive surface is occupied by the pegs.

The distribution on the surface may result in a particular density of protrusive engineered elements 220 per square inch. In some implementations, the structured adhesive surface comprises no greater than 30,000 elements per square inch, in some embodiments no greater than 25,000, in some embodiments no greater than 20,000, in some embodiments no greater than 15,000, in some embodiments no greater than 12,500, in some embodiments no greater than 10,000 elements per square inch.

Another embodiment of a stretch releasable adhesive article 300 that includes an assortment of particles 320 is depicted in FIG. 5. In general, the particles 320 may be solid, hollow or porous and rigid or non-rigid. The particles 320 may be made of any suitable material including wood, glass, ceramics, polymers, metals, metal oxides, and carbon materials. The particles 320 are generally in the size range of from about 1 micron to about 2540 microns. Different particles can be distributed across the adhesive surface 312.

The distribution can also contain multiple compositions, types, or sizes of particles. The particles 320 can be arranged in a particular shape or can be distributed unevenly. The surface of the particles 320 may be treated or functionalized to be hydrophobic or to be hydrophilic. The particles 320 can be agglomerated or non-agglomerated and aggregated or non-aggregated. “Agglomerate” refers to a weak association between primary particles which may be held together by charge or polarity and can be broken down into smaller entities. “Aggregate” refers to strongly bonded or fused particles where the resulting external surface area may be significantly smaller than the sum of calculated surface areas of the individual components. The forces holding an aggregate together can include strong forces, for example, covalent bonds, or those resulting from sintering or complex physical entanglement. An aggregate may also be held together by reversible or temperature dependent bonds (e.g., ionic bonds).

In some embodiments, the engineered surface elements 320 include inorganic particles. The inorganic particles can be natural or synthetic. The term “synthetic inorganic particles” as used herein includes any particles that has been transformed, regenerated, recrystallized, reconstituted, etc., from an original state which may be its naturally occurring, mined state into its current state by a chemical synthesis process (e.g., precipitated from solution, generated by flame hydrolysis, etc.) or by a physical synthesis process (e.g., precipitated from a gaseous phase, solidified by way of a sol-gel process, etc.). The term “synthetic inorganic filler” as used herein also includes any filler that has been substantially transformed from an original state (which may be its naturally occurring, mined state) into its current state by a physical synthesis process of being brought into an at least partially softened or molten state and then solidified by cooling, such that any substantially crystalline structure that may have existed in the natural state is substantially erased such that the material is now in a substantially amorphous form (e.g., comprising less than about 0.5 percent crystallinity by weight). Such processes may include, for example, melt processing, flame-fusion and the like. Conversely, “natural inorganic particles” is defined as a mineral that has been extracted from the earth in its naturally occurring form, and, while possibly being subjected to purification and/or modification processes is used while still substantially in its naturally occurring form.

Using the definitions provided above, synthetic inorganic particles include, for example, so-called glass bubbles or microspheres (such as those available from 3M Company of St. Paul, Minn., under the trade designation 3M Glass Bubbles), ceramic microspheres (such as those available from 3M Company under the trade designation 3M Ceramic Microspheres), synthetic clays (e.g., synthetic silicate clays such as those available under the trade designation Laponite from Southern Clay Products of Gonzales, Tex.), precipitated silica, fumed silica, vitreous silica, synthetic titanium dioxide (as made, for example, by the sulfate process or the chloride process), synthetic (precipitated) calcium carbonate (as made, for example, by passing carbon dioxide through a solution of calcium hydroxide), and the like. Such glass bubbles can be synthesized, for example, by a process as described in U.S. Pat. Nos. 3,365,315 and 4,391,646, incorporated herein in their entirety. Such ceramic microspheres can be synthesized, for example, by sol-gel processes, as described for example in U.S. Pat. Nos. 3,709,706 and 4,166,147, incorporated herein in their entirety. Other methods potentially useful for making ceramic particles and/or microspheres are described in, for example, U.S. Pat. No. 6,027,799, incorporated herein in its entirety.

Suitable natural inorganic particles include calcite, witherite, rutile, anatase, ilmenite, mica, sericite, perlite, talc, limestone, silica, barite, gypsum, calcined gypsum, kaolinite, montmorillonite, attapulgite, illite, saponite, hectorite, beidellite, stevensite, sepiolite, bentonite, pyrophyllite, diatomaceous earth, and the like, as well as mixtures thereof.

If used as non-adhesive elements, polymeric particles may be made of any suitable polymeric material. Polymeric particles may be made of rigid materials or elastomeric materials. Suitable rigid polymeric materials include thermosetting polymers, e.g., phenolic polymers, or thermoplastic polymers, e. g., polyvinylidene chloride acrylonitrile copolymers (PVDC copolymers). Exemplary elastomeric microspheres are described in U.S. Pat. No. 3,691,140 to Silver, U.S. Pat. Nos. 3,857,731 and 4,166,152 to Baker et al.

Other suitable polymeric particles include fluid-filled microspheres comprising an acrylonitrile/methyl methacrylate thermoplastic copolymer, such as those sold under the tradename EXPANCEL® by Akzo Nobel. In another aspect, the polymeric particles can include a shell consisting of either acrylonitrile copolymer or polyvinylidene chloride copolymer with a calcium carbonate coating, such as those sold under the tradename DUALITE® by Henkel.

Other exemplary particles include fused aluminum oxide, heat treated aluminum oxide, white fused aluminum oxide, black silicon carbide, green silicon carbide, titanium diboride, boron carbide, tungsten carbide, titanium carbide, diamond (both natural and synthetic), silica, iron oxide, chromia, ceria, zirconia, titania, silicates, tin oxide, cubic boron nitride, garnet, fused alumina zirconia, sol gel particles, and the like, as well as mixtures thereof.

Typically, the particles used in the core have an average primary (in some embodiments, average primary and agglomerate) particle size (e.g., diameter) of no greater than 1 micron. “Primary particle size” refers to the largest dimension (e.g., the diameter of a spherical particle) of a single (non-aggregated, non-agglomerated) particle. In some embodiments, the particles have an average primary (in some embodiments, average primary and agglomerate) particle size of no greater than 0.1 micron. In some embodiments, the particles are substantially spherical and have a diameter from about 10 microns to about 100 microns, such as from about 40 microns to about 80 microns, or from about 50 microns to about 70 microns.

Under presently preferred conditions, the particles used as non-adhesive elements cause the adhesive layer to have a non-planar available adhesive surface. Once an adhesive article has been positioned, it can be adhered to the mounting surface by applying sufficient pressure to fracture the particles and/or drive the particles into the base adhesive layer, thereby bringing adhesive in the base adhesive layer into sufficient contact with the mounting surface. The discontinuities in the adhesive layer enable reduced surface contact between the stretch releasable adhesive layer and the mounting surface to provide temporary adhesion until a quantity of pressure is applied sufficient to deform or rupture the non-adhesive elements so a greater surface area of the adhesive makes contact with the mounting surface.

The particles can be substantially spherical in shape. However, other shapes such as elongated shapes may alternatively be employed. Examples of such shapes include rods, triangles, platelets, pyramids, cones, solid spheres, hollow spheres and the like. Also, the particles may be randomly shaped.

For any of the distributions of particles described herein, the area of the non-adhesive surface is typically dictated by at least one the packing density of the particles and the method used to distribute the particles on the adhesive surface. In some embodiments, no greater than 80% of the total area on the adhesive surface 312 includes particles, in some embodiments no greater than 75% of the area, in some embodiments no greater than 70%, in some embodiments no greater than 65%, in some embodiments no greater than 60%, in some embodiments no greater than 50%, in some embodiments no greater than 40%, and in yet additional embodiments no greater than 30% of the total area includes particles. In certain circumstances, a non-adhesive region exceeding 50% of the total area may detract from the shear strength of the adhesive article or interfere with establishing an application bond.

Any of the prior implementations of protrusive engineered features described above may be combined with intrusive features. Intrusive features (e.g., recessed features) can generally be described as features having surface points that lie below an average elevation of the adhesive surface. Recessed features, for example, can be referred to as recesses, wells, cavities, concavities, pockets, channels, and the like. Recessed features can have a volume with dimensions such as diameter, radius, depth, length, and width. A base of the recessed feature can generally refer to a location within the recessed feature having points lying closest to an average elevation, while the surface or region of the recess farthest from the average elevation is considered an apex.

In particular embodiments, the intrusive features define channels in the adhesive layer. The channels may be utilized to create exit pathways for fluid egress to a periphery of the article when the article is applied to a desired adherend. Channels are continuous open pathways or grooves that extend into the adhesive from the exposed surface. The channels typically either terminate at the peripheral portion of the adhesive layer or communicate with other channels that terminate at a peripheral portion of the article. Upon application of the article onto a substrate, the pathways provide an egress to a periphery of the article for fluid (particularly air) trapped at the interface between the adhesive and the substrate.

The channels are typically created to define a specific volume per any given area of the surface of the adhesive. The minimum volume per unit area of the adhesive ensures adequate egress for fluids at the interface of the intended adherend and the adhesive. Typically, the channels define a volume of at least 1*10³ μm³ per any 500 μm diameter circular area in a two-dimensional plane of the adhesive layer.

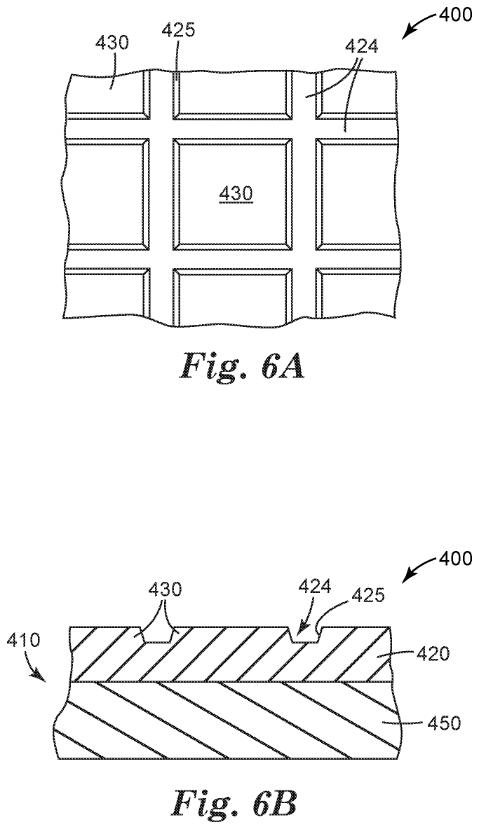

The shape of the channels can vary according to the processing methods, but each typically has a V-shaped, U-shaped, rectangular or trapezoidal cross section on observation in a transverse direction. FIGS. 6A and 6B shows a segmented view of a stretch releasable article 400 highlighting trapezoidal channels 424 in an adhesive construction 410. The adhesive construction 410 includes a backing 450 and an adhesive 420, though adhesive only constructions are also possible. The trapezoidal channels 424 and corresponding land structures 430 defined by the channels are formed in the adhesive 420. Side walls 425 of the channels 424 define side walls for the land structures 430.

Though not depicted, the exposed major surface 434 of the land structures will include a distribution of protrusive engineered elements of the types described above. In some embodiments, the exposed major 434 surface of the land structures includes an arranged pattern of deadening material. In some embodiments, the exposed major surfaces 434 comprises an arranged pattern of one or more adhesive or composite pegs, as exemplified in U.S. Pat. No. 6,197,397 (Sher et al.). In other embodiments, the exposed major surface 434 comprises an assortment of particles. In certain embodiments, the channels are substantially free of protrusive engineered features, though this is not strictly necessary.

The limits of dimensions of the channels can be described by use of the aspect ratio. The aspect ratio is defined as the ratio of the greatest microscopic dimension of the channel parallel to the plane of the continuous layer of adhesive to the greatest microscopic dimension of the channel perpendicular to the plane of the continuous layer of adhesive. The aspect ratio is measured by taking the cross-sectional dimensions of the channel at an angle perpendicular to the wall of the channel. Depending on the specific type of channel, the limits of the aspect ratio would be about 0.1 to about 20. For example, the structures of FIGS. 6A and 6B would define channels that would have a presently preferred aspect ratio of about 10 to about 15.

Channels are generally created by embossing or forming a plurality of structures into the adhesive. The structures may be present in either a random array or in regular patterns. Individual structures at least partially define a portion of a channel in the adhesive. Selected patterns could include rectilinear patterns, polar patterns and other conventional regular patterns. A plurality of structures combines to create the continuous channels on the surface of the adhesive.

The shape of the land structures formed in the adhesive can vary. Examples of land structure shapes include but are not limited to those selected from the group consisting of hemispheres, prisms (such as square prisms, rectangular prisms, cylindrical prisms and other similar polygonal features), pyramids, or ellipsoids. Combinations of the different structure shapes can be utilized. Each individual structure typically has a height, as measured from the apex of the defining channels, of greater than about 3 micrometers but less than the total thickness of the adhesive layer, and preferably about 3 micrometers to about 50 micrometers. Additionally, some of the land structures may be truncated to provide a surface for additional engineered elements, to control the contact surface of the adhesives, and to improve the wet out of the adhesive. The land structures can be arranged at a pitch of about 400 μm or less, and in some embodiments about 300 μm or less.

The structured adhesive surface including intrusive features has a total are “T”, a first area “A” for land structures, and an area “B” for channels. The percentage of “A” to “T” can range from about 35% to about 99%. In other embodiments, the percentage can range from about 50% to about 98%, about 60% to about 97%, about 70% to about 96%, and about 85% to about 95%. The latter range can typically provide adequate fluid egress without substantially compromising adhesion to typically desired adherends. The percentage of “B” to “T” is accordingly the remaining percentage in the each of the above.

The intrusive features can be made by imparting a topographical surface onto an adhesive with practices conventionally recognized in the art. The features are imparted by embossing the adhesive directly through utilization of molding tools or by coating the adhesive onto a liner or backing previously embossed with an inverse pattern of features. Such methods and practices are exemplified in U.S. Pat. No. 5,650,215 (Mazurek et al.) and U.S. Pat. No. 9,085,121 (Mikami et al.), each of which is incorporated in its entirety herein. Intrusive features may be created contemporaneously with the protrusive features or may be imparted to the adhesive surface before or after the creation of the protrusive, engineered features.

The combination of fluid egress channels and protrusive, engineered elements can provide a measure of repositionability to stretch release adhesive articles of the present disclosure. That is, the article can be placed on a surface with a contact bond, removed, and reapplied to the same or different location at least once. The article can then be subjected to pressure sufficient to form a viable application bond. In presently preferred embodiments, the combination of fluid egress channels and adhesive containing pegs provides a suitable degree of repositionability without unduly sacrificing shear strength and wet out. In particularly advantageous embodiments, the adhesive article featuring fluid egress channels and protrusive engineered elements can withstand a mounting weight (i.e., load) of at least 6 lbs without damaging in the substrate according to the Repositionability 1 test below. In yet more advantageous embodiments, the adhesive articles of at least 8 lbs, or at least 10 lbs without damaging in the substrate according the Repositionability 1 test below. Without wishing to be bound by theory, the higher mounting weight before damage equates to a user's potential or likely applied force when selecting an initial position for the adhesive article; the user may be conditioned to press hard or may have little intuitive feel for “light” pressure, and the ability to maintain repositionability despite higher application forces could be advantageous for certain mounting applications.

Adhesive Articles

Adhesive articles of the present disclosure typically have excellent shear strength. Some embodiments of the present disclosure have a shear strength of greater than 1600 minutes as measured according to ASTM D3654-82. Some embodiments of the present disclosure have shear strength of greater than 10,000 minutes as measured according to ASTM D3654-82. Some other embodiments of the present disclosure have shear strength of greater than 100,000 minutes as measured according to ASTM D3654-82. In presently preferred implementations of the present disclosure, the adhesive article combines excellent shear strength with a sliding force not exceeding 30 oz on painted drywall (according to the Sliding test described below).

Some adhesive articles of the present disclosure demonstrate improved weight bearing capacity, holding a 3, 6, or 9 lbs weight for at least 15 days according to the Package Weight Claim test. In presently preferred embodiments, the adhesive articles of the present disclosure demonstrate improved weight bearing capacity, holding a 3, 6, or 9 lbs weight for at least 30 days according to the Package Weight Claim test.

In some embodiments, the adhesive article has an elongation at break of at least 400%. Some adhesive articles of the present disclosure have an elongation at break of between about 400% and about 1500% in at least one direction. In some embodiments, the stretch releasable article can be stretched at least 100 percent, at least 150 percent, at least 200 percent, at least 300 percent, at least 400 percent, or at least 500 percent without breaking. The stretch releasable layer and/or film can often be stretched up to 1500 percent, up to 1200 percent, up to 1000 percent, up to 800 percent, up to 750 percent, or up to 700 percent without breaking. These relatively large elongation values facilitate stretch releasing of the adhesive articles of the present disclosure after being adhered to a substrate. Some adhesive articles of the present disclosure have a tensile strength at break sufficiently high so that the adhesive article will not rupture prior to being stretched and removed from an adherend at an angle of 35° or less.

In some embodiments, the adhesive article exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive article exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments that use a backing in the adhesive construction, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments, have a haze of no greater than 20%. Some embodiments, have a haze of no greater than 20%. Both the light transmission and the haze of the carrier (or at least some of the layers thereof) can be determined using, for example, ASTM D1003-95.

In some embodiments, the adhesive article further includes a tab. The tab is an area that can be easily accessed by the user to assist in or begin to stretch release the adhesive article from the adherend. The removal tab can be tacky from the outermost adhesive layer or non-tacky by being covered by layers of stretch film, non-stretch film, release liner, or from detackified adhesive.

In some embodiments, the adhesive article further includes one or more release liners. The release liner can be, for example, on either or both of the major surfaces of the stretch releasable adhesive layers. The release liner protects the adhesive during manufacturing, transit, and before use. When the user desires to use the adhesive article, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone polycoated paper. The release liners can be printed with lines, brand indicia, or other information.

In some embodiments, the adhesive article has a thickness that is between about 2 mil and about 40 mils. In some embodiments, the thickness is greater than 3 mil, greater than 4 mil, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

In some embodiments, a force of between about 1N and about 50N per inch width is required to strain the adhesive article 10% in tensile elongation as measured according to ASTM D638-14 and/or ASTM D412-06a. In some embodiments, a force of between about 2N and about 30N per inch width is required to strain the adhesive article 10% in tensile elongation as measured according to ASTM D638-14 and/or ASTM D412-06a. In some embodiments, a force of between about 3N and about 15N per inch width is required to strain the adhesive article 10% in tensile elongation as measured according to ASTM D638-14 and/or ASTM D412-06a.

In some embodiments, the adhesive article has an elongation at break of at least 400%. Some adhesive articles of the present disclosure have an elongation at break of between about 400% and about 1500% in at least one direction. In some embodiments, the stretch releasable article can be stretched at least 100 percent, at least 150 percent, at least 200 percent, at least 300 percent, at least 400 percent, or at least 500 percent without breaking. The stretch releasable layer and/or film can often be stretched up to 1500 percent, up to 1200 percent, up to 1000 percent, up to 800 percent, up to 750 percent, or up to 700 percent without breaking. These relatively large elongation values facilitate stretch releasing of the adhesive articles of the present disclosure after being adhered to a substrate.

In some embodiments, the adhesive article can further include a separable connector. Some exemplary separable connectors are described in, for example, U.S. Pat. Nos. 6,572,945; 7,781,056; 6,403,206; and 6,972,141, all of which are incorporated by reference in their entirety herein.

Constituent elements of the adhesive articles described herein are explored in more detail below.

Backing

If used, the backing can be a single layer or a multilayer construction. More than one backing layer can be present in the backing. Multiple backing layers can be separated by layers of film, which may further contain one or more layers. In some embodiments, the backing includes at least one of plastic, metal, paper, nonwoven material, textile, woven material, foam, adhesive, gel, and/or a filament reinforced material. In some embodiments, the backing is at least one of a single layer of material or a multilayer film. In other embodiments, the backing can be an arrangement of particles disposed between adjacent adhesive layers.

In some embodiments, two or more sub-layers can be co-extruded so as to form the backing. In some embodiments, the backing is flexible. Some embodiments include dyes or pigments in the backing layer. Some embodiments include at least one tackifier in at least one layer of the backing. Some embodiments include a plasticizing oil in one or more layers of the backing.

The backing can be any desired shape including, for example, square, rectangle, triangular, polygon, circular, quadrilateral, trapezoidal, cylindrical, half-circular, star-shaped, half-moon shaped, tetrahedral, etc.

The backing can be made of any desired material or materials. Representative examples of materials suitable for the backing can include, for example, polyolefins, such as polyethylene, including high density polyethylene, low density polyethylene, linear low density polyethylene, and linear ultralow density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadienestyrene copolymers, and ethylene/propylene copolymers; acrylic polymers and copolymers; polyurethanes; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used.

In some embodiments, the backing is or includes a composite foam that includes a flexible polymeric foam layer, a first film laminated to a first major surface of the foam layer, and a second film laminated to a second, opposite major surface of the foam layer. Adhesive(s) can be attached to the films to form a structure of adhesive-film-foam-film-adhesive. The flexible polymeric foam layer can be chosen to optimize conformability and resiliency properties which are helpful when an adhesive article is to be adhered to surfaces having surface irregularities. Such is the case with a typical wall surface. An exemplary flexible polymeric foam layer is commercially available under the trade designation “Command” from 3M Company of St. Paul, Minn. In some embodiments, the flexible polymeric foam layer of the backing can include polyolefin foams which are available under the trade designations “Volextra” and “Volara” from Voltek, Division of Sekisui America Corporation, Lawrence, Mass. In some embodiments, the backing is or includes a metal or is metal-like. In some embodiments, the backing is or includes wood or is wood-like.

The backing can be or include one of the materials or backings described in any of the following patent applications, all of which are incorporated in their entirety herein: US Provisional Application Nos. (assigned to the present applicant) 62/622,387, 62/526,200, and 62/477,844; PCT Application No. US2017/016039 (Runge et al.); and WO Publication No. 2015/195344, all assigned to the present assignee.

In some embodiments, the backing material has a storage modulus of between about 15×10³ Pa and about 2.5×10⁶ Pa at 25 degrees Celsius. In other embodiments including those with glass materials or other ceramics, the backing material can have a storage modulus of up 1×10¹⁰ Pa. In some embodiments, the backing material has a tan δ (where tan δ is the loss modulus divided by the storage modulus) of between about 0.4 and about 1.2 at 25 degrees Celsius. In some embodiments, the backing has a glass transition temperature of between about −125 and about 40 degrees Celsius. In other embodiments, the backing material has a stress relaxation between 10% and 100% after 10 seconds.

In some embodiments, the backing exhibits an elastic recovery of 1-99% at 10% strain. In some embodiments, the backing exhibits an elastic recovery of 1-99% at 20% strain. In some embodiment of the disclosure, the backing material has an elongation at break of greater than 50% in at least one direction. In some embodiment of the disclosure, the backing material has an elongation at break of between about 50% and about 1200% in at least one direction.

In some embodiments, the backing has a Young's modulus of between about 100 psi and about 100,000 psi. In other embodiments featuring glass materials or ceramics, the backing may have a Young's modulus of up to 10,000,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, the backing has a modulus of elasticity and/or a modulus of secant of between about 100 psi and about 15,000 psi as determined by at least one of ASTM D638-14 and ASTM D412-06a. In some embodiments, the backing has a modulus ranging between 100 psi and 15000 psi. In some embodiments the modulus is greater than 100 psi, greater than 500 psi, greater than 1000 psi. In some embodiments the backing modulus is less than 15000 psi, less than 10000 psi, less than 8,000 psi, less than 5,000 psi, less than 3,500 psi, less than 2000 psi, and less than 1500 psi.

In some embodiments, the backing has a thickness of between about 0.1 mils and about 100 mils. In some embodiments, the backing has a thickness of greater than 1 mil, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

Adhesive

The adhesives used in the adhesive articles described herein can include any adhesive having the desired properties. In some embodiments, the adhesive is stretch releasable. As used herein, the term “stretch-releasable” means removable from the surface of an adherend by stretching in the direction of the bond plane to an elongation of greater than 50%. In some embodiments, the adhesive releases cleanly from the surface of an adherend when the adhesive article is stretched at an angle of about 35° or less from a surface of the adherend. In some embodiments, the stretch releasable adhesive releases from a surface of an adherend when the multilayer carrier is stretched at an angle of about 35° or less from the adherend surface such that there are substantially no traces of the adhesive left behind on the surface of the adherend.

In some embodiments, the stretch releasable adhesive is a pressure sensitive adhesive. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure sensitive adhesive. Exemplary pressure sensitive adhesives utilize one or more thermoplastic elastomers, e.g., in combination with one or more tackifying resins. Some exemplary stretch releasable adhesives that can be used in the adhesive articles described herein include, for example, those described in U.S. Pat. No. 6,569,521 or International Publications WO/2017/136188, WO/2017/136219, or US Publication No. 2016/0068722, each of which is incorporated herein in its entirety. In some embodiments, the adhesive layer includes one or more hydrocarbon block copolymers; and a polar phenolic tackifier comprising a phenolic moiety and having a hydroxyl value of between 20 to 130 and an acid value of less than 0.5. In some embodiments, the adhesive includes at least one of the polar phenolic tackifiers is a terpene phenol.

Some stretch releasable adhesives that can be used in the adhesive articles of the present disclosure have a glass transition temperature of about −125° C. to 20° C., as determined by dynamic mechanical analysis of the tan δ peak value. Some stretch releasable adhesives that can be used in the adhesive articles of the present disclosure have a storage modulus of about 400,000 Pa or less, or 300,000 or less at 25° C., as determined by dynamic mechanical analysis.

In some embodiments, the thickness of the stretch releasable adhesive on at least one of the first or second major surfaces of the multilayer carrier is about 1 μm to about 1 mm.

In some embodiments, the stretch releasable adhesives are tailored to achieve removal with no or minimal damage. Exemplary methods and articles for doing so are described in, for example, U.S. Pat. No. 6,835,452 and International Application Number (assigned to the present assignee) PCT/US2017/048654, each incorporated herein in its entirety.

Hardgoods

Some embodiments further include a hardgood or mounting device. Exemplary hardgoods or mounting devices include, for example, hooks, knobs, clips, and loops. In some embodiments, the hardgood resembles a nail. In some embodiments, the hardgood has a single outward projection to act as a hanging surface. In some embodiments, the hardgood has multiple outward projections to act as a hanging surface. In some embodiments, the hardgood has is molded into a shape that can hold one or more items within such as but not limited to a box or caddy. In some embodiments, the hardgood is a shelf, ledge, or rack. In some embodiments, the hardgood is a bar wherein the bar can be straight or curved or substantially a ring wherein the bar can be mounted parallel or normal to the substrate surface. In some embodiments, the hardgood uses multiple methods for mounting or hanging items. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein. The hardgood may be any object to be mounted to a substrate.

In some embodiments, the hardgood is mounted to the substrate in one or more places wherein one or more of the mounting locations contain an adhesive article described in this invention. In some embodiments, the hardgood is mounted using a combination of removable article(s) and conventional mechanical fasteners including but not limited to nails, screws, bolts, and rivets.

In some embodiments, the hardgood is made from of thermoplastic polymers. In some embodiments, the hardgood is made from thermoset polymers. In some embodiments, the hardgood is made using polyolefin materials. In some embodiments, the hardgood is made using polycarbonate materials. In some embodiments, the hardgood is made using high-impact polystyrene. In some embodiments, the hardgood is made using acrylonitrile-butadiene-styrene (ABS) terpolymers. In some embodiments, the hardgood is made using two or more polymeric materials. In some embodiments, the hardgood is made from metal. In some embodiments, the hardgood is made from stainless steel. In some embodiments, the metal is painted, glazed, stained, brushed, or coated to alter its appearance. In some embodiments the hardgood is made from ceramic. In some embodiments, the hardgood is made from glazed ceramic. In some embodiments, the hardgood is made from unglazed ceramic. In some embodiments, the hardgood is comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the hardgood is made using two or more materials from the list above. In some embodiments, the hardgood is made from two pieces that are reversibly or irreversibly attached, joined, or welded together.

In some embodiments, the hardgood comprises two pieces wherein the first piece acts as a mounting surface for attaching the adhesive article to a substrate, and the second piece acts as a hanging member which may be used for hanging or mounting objects to the substrate. The two pieces may be reversibly attached using mechanical fasteners, hook and loop materials, or an additional adhesive layer.

The hardgood can be made using any method known in the art. In some embodiments, a backing and/or the stretch releasable adhesive layer(s) may be attached manually by the end user.

### Methods of Making

The adhesive mounting assemblies described herein can be made in various ways. In some embodiments, the adhesive can be directly coated onto a major surface of the backing. In other embodiments, the adhesive can be formed as a separate layer (e.g., coated onto a release liner) and then laminated to the backing.

Adhesive mounting assembly can be formed as a single component construction whereby, for example, the adhesive mounting assembly is cast or molded using a single material or multiple materials. Alternatively, adhesive mounting assembly can be formed as a two-component construction whereby a separately formed mounting device is adhered or attached to a separately formed backing during, for example, manufacturing or consumer use.

The adhesive can be prepared using a variety of common methods for preparing adhesives. For example, the adhesive composition can be coated onto a release liner, coated directly onto a backing, or formed as a separate layer (e.g., coated onto a release liner) and then laminated to a backing. In some embodiments, the adhesive can be formed simultaneously with the backing. For example, a multilayer film consisting of at least two layers, at least one of which is an adhesive, can be coextruded. In some embodiments, the construction can be formed in a cast or blown film construction.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

For adhesive articles featuring non-adhesive elements with deadening material, the deadening material may be applied to a surface of the adhesive according to any available method. In certain embodiments, the deadening material can be deposited (e.g., by printing an ink pattern) onto a release liner and transferred to an adhesive layer. In certain embodiments, the release liner is provided to cover and protect the external surface of adhesive, where the deadening material is at least partially embedded therein such that when the release liner is peeled from the adhesive, the deadening material remains with the adhesive. Peeling the release liner from the adhesive layer can simultaneously create selected areas having modified adhesive functionality. Methods for transferring a deadening material are described in International Publication No. WO2018/106489, entitled Methods of Passivating Adhesives.

Solid particles may be distributed on the surface of an adhesive construction using any means capable of applying a powder in the dispersed state, such as an ordinary powder applicator, a powder sprinkler, or a powder sprayer. Alternatively, the solid particles are dispersed in a suitable dispersing medium, and the resulting slurry is applied to the surface of the adhesive construction by coating or spraying, dipping, or otherwise, followed by drying. It is also possible to distribute an excessive amount of the particles and then remove the excess of the particles by a brush or other suitable scraper means. The solid particles may be applied directly to the intended surface of the adhesive construction. Or it may first be applied to a suitable carrier and then transferred to the adhesive construction.

The post or pegs useful as engineered structures may be created in the adhesive construction according to at least the methods outlined in U.S. Pat. No. 5,296,277 (Wilson et al.) and U.S. Pat. No. 5,795,636 (Keller et al.). Intrusive features, and combinations of intrusive and protrusive features, may be created according to at least the methods outlined in U.S. Pat. No. 6,197,397 (Sher et al.).

Methods of Using the Adhesive Articles Described Herein

The adhesive articles of the present disclosure can be used in various ways. In some embodiments, the adhesive article is applied, attached to, or pressed into an adherend. In this way, the adhesive article contacts the adherend. Where a release liner is present, the release liner is removed before the adhesive article is applied, attached to, or pressed into an adherend. In some embodiments, at least a portion of the adherend is wiped with alcohol before the adhesive article is applied, attached to, or pressed into an adherend.

To remove the adhesive article from the adherend, at least a portion of the adhesive article is peeled or stretched away from the adherend. In some embodiments, the angle of stretch is 35° or less. In embodiments where a tab is present, the user can grip the tab and use it to release or remove the adhesive article from the adherend.

The adhesive articles can be used in isolation, as one of many articles attached to a surface, or as part of a stack of adhesive articles. In the latter implementation, the resulting construction would include a plurality of adhesive articles disposed in vertical relation to one another.

Uses

The adhesive articles may be used in wet or high humidity environments such as those found in bathrooms. For example, they can be adhered to toilets (e.g., toilet tanks), bathtubs, sinks, and walls. The adhesive article may be used in showers, locker rooms, steam rooms, pools, hot tubs, and kitchens (e.g., kitchen sinks, dishwashers and back splash areas, refrigerators and coolers). The adhesive article may also be used in low temperatures applications including outdoor applications and refrigerators. Useful outdoor applications include bonding articles such as signage to outdoor surfaces such as windows, doors land vehicles.

The adhesive articles may be used to mount various items and objects to surfaces such as painted drywall, plaster, concrete, glass, ceramic, fiberglass, metal or plastic. Items that can be mounted include, but are not limited to, wall hangings, organizers, holders, baskets, containers, decorations (e.g., holiday decorations), calendars, posters, dispensers, wire clips, body side molding on vehicles, carrying handles, signage applications such as road signs, vehicle markings, transportation markings, and reflective sheeting.

The adhesive articles may be used to mount items and materials, such as anti-slip mats or anti-fatigue mats, to a floor surface or the bottom of a tub or shower, or to secure items, such as area rugs, to a floor. The adhesive article can be used in various joining and assembling applications including such as adhering at least two containers (e.g., boxes) for later separation. The adhesive article can be used in various cushioning and sound deadening applications such as, for example, cushioning materials for placement beneath objects, sound insulating sheet materials, vibration dampening, and combinations thereof. The adhesive article can be used in various closure applications including container closures (e.g., box closures, closures for food containers, and closures for beverage containers), diaper closures, and surgical drape closures. The adhesive article can be used in various thermal insulation applications.

The adhesive article can be used in various sealing applications such as in gaskets for liquids, vapors (e.g., moisture), and dust. The adhesive article can be used in various labels such as removable labels (e.g., notes, price tags, and identification labels on containers), and in signage. The adhesive article can be used in various medical applications (e.g., bandages, wound care, and medical device labeling such as in a hospital setting). The adhesive article can be used in various fastening applications such as fastening one object (e.g., a vase or other fragile object) to another object (e.g., a table or a book shelf). The adhesive article can be used in various securing applications such as fastening one or more components of a locking mechanism to a substrate (e.g., a child safety lock can be adhered to a cabinet or cupboard). The adhesive article can be used in various tamper indicating applications (e.g., tamper indicating articles). The adhesive article can also be incorporated in a variety of other constructions including, but not limited to, abrasive articles (e.g., for sanding), articles for sanding and polishing applications (e.g., buffing pads, disc pads, hand pads, and polishing pads), pavement marking articles, carpeting (e.g., backing for carpeting), and electronic devices (e.g., securing a battery within a housing in a cell phone or PDA (personal digital assistant) to prevent unwanted movement).

The adhesive article (i.e., those in adhesive tapes or single article) can be provided in any useful form including, e.g., tape, strip, sheet (e.g., perforated sheet), label, roll, web, disc, and kit (e.g., an object for mounting and the adhesive tape used to mount the object). Likewise, multiple adhesive articles can be provided in any suitable form including, e.g., tape, strip, sheet (e.g., perforated sheet), label, roll, web, disc, kit, stack, tablet, and combinations thereof in any suitable package including, for example, dispenser, bag, box, and carton.

The adhesive articles can also be used to affix a substrate, such as an optical lens or cover, to an optical display device, such as a cellular telephone or portable music player (e.g., MP3 players). In such end use applications, it can be desirable that the adhesive article be optically clear.

In some embodiments, the surface to which the adherend is adhered is at least one of drywall, glass, tile, paint, veneer, wood, or other common household surfaces. In some embodiments, the surface is painted. In some embodiments, the surface is painted with a low or no VOC paint.

The following examples describe some exemplary constructions and methods of constructing various embodiments within the scope of the present application. The following examples are intended to be illustrative, but the particular materials and amounts thereof recited in these examples, as well as other conditions and details, should not be construed to unduly limit this disclosure.

### EXAMPLES

Test Adherends

Drywall panels (obtained from Materials Company, Metzger Building, St. Paul, Minn.) were painted with Behr PREMIUM PLUS ULTRA® Primer and Paint 2 in 1 Flat Egyptian Nile (FEN) (“Behr FEN PPU” or “FEN”) obtained from Behr Process Corporation of Santa Ana, Calif.) or Sherwin-Williams DURATION®, Interior Acrylic Latex Ben Bone White or beige Paint ((“SW Ben Bone” or “Ben Bone”) obtained from the Sherwin-Williams Company of Cleveland, Ohio). Glass panels of 2*2 in2 or 12*6 in2 were also used as s substrate for PWC and shear testing.

Procedure for painting: a first coat of paint was applied to a panel by paint roller, followed by air drying for 24 hours at ambient conditions. A second coat of paint was applied and dried at ambient conditions for 24 hours. The panel was placed in a forced air oven set to 50° C. for 7 days. Then the panel was then stored at ambient conditions until use.

Test Methods Test Substrates

Drywall panels (obtained from Materials Company, Metzger Building, St. Paul, Minn.) were painted with Behr PREMIUM PLUS ULTRA Primer and Paint 2 in 1 Flat Egyptian Nile (“Behr PPU FEN”) or Behr MARQUEE Interior Paint Deep Royal (“Behr MARQUEE DR”) obtained from Behr Process Corporation of Santa Ana, Calif., or Sherwin-Williams DURATION, Interior Acrylic Latex Ben Bone White or Beige Paint (“SW Ben Bone”) obtained from the Sherwin-Williams Company of Cleveland, Ohio.

Procedure for painting: a first coat of paint was applied to a panel using a paint roller, followed by air drying for 24 hours at ambient conditions. A second coat of paint was applied and dried at ambient conditions for 7 days and stored at ambient conditions until use.

Glass panels, 2 in×2 in (5.1 cm×5.1 cm) or 6 in×12 in (15.3×30.5 cm), were also used as test substrates (non-tin side) for Package Weight Claim testing and Shear Strength testing.

Package Weight Claim

Package Weight Claim testing was performed using medium size COMMAND utility hooks (Type 17001ES, available from 3M Company, St. Paul, Minn.). Test samples were cut into ⅝ in×2 in (1.6 cm×5.1 cm) strips. The second adhesive side of the test sample (not ink passivated or structured adhesive side) was first applied to the backplate or mounting base of the COMMAND utility hook. The opposing first adhesive side of the test sample (ink passivated or structured adhesive side) was then applied to the test substrate. The test samples were subsequently pressed down for 10 seconds by hand with light pressure (approximately less than 5 lbs). The test samples were then pressed down for 30 seconds by hand with firm pressure (approximately greater than 15 lbs) to assure the proper wet-out of the adhesive to the substrate. The samples were mounted in a vertical position and allowed to dwell on the test substrate for 60 minutes at ambient conditions (between 69-72° F. (21-22° C.) and 10-40% relative humidity, depending on the time of year) before attaching a load to the test sample (3, 6, or 9 lb weights). Samples were hung until failure or until 30 days had elapsed. Failure was indicated when it was observed that hook article completely fell off the test substrate (the adhesive no longer adhered to the test substrate surface). The Package Weight Claim data in the Tables is provided as Weight Holding Power (days). The data are an average of 3 tests.

Shear Strength

Shear strength was determined according to the ASTM D3654-06 (2011) method. A 0.5 in×0.5 in (1.3 cm×1.3 cm) square piece the test sample was applied to the test substrate using the first adhesive side of the test sample (ink-passivated or structured adhesive side). A ⅝ in×3 in (1.6 cm×7.6 cm) strip of metalized PET film was then attached to the opposing second adhesive side of the test sample (not ink passivated or structured adhesive side). The metalized PET was folded back onto itself and stapled to provide a means to hang a hanger for attaching a weight. A 15 lb (6.8 kg) hand held roller was passed over the length of the sample two times at a rate of about 12 in/min (30.48 cm/min). The samples were mounted in a vertical position and allowed to dwell on the test substrate for 60 minutes at controlled temperature and humidity conditions of 72° F. (22° C.) and 50% relative humidity before attaching a 1000 gram weight. Samples were hung until failure or until 25,000 minutes had elapsed (note that 10,000 minutes is the ASTM time limit). Failure was indicated when it was observed that test sample completely fell off the test substrate. The Shear Strength in the Tables are an average of 3 tests.

Sliding (Positionability)

A test method for quantifying initial “slide-ability” was developed using an IMASS SP-2100 Slip/Peel Tester (available from IMASS Inc., Accord, Mass.). Samples were tested on drywall panels painted with Sherwin-Williams DURATION, Interior Acrylic Latex Ben Bone as described above, and on glass, at various weights to simulate typical finger pressure that would be incurred while sliding. “Slide-ability” was measured by recording force (oz) required to slide. Test samples were cut into ⅝ in×2 in (1.6 cm×5.1 cm) strips. The second adhesive side of the test sample (not ink passivated or structured adhesive side) was first applied to a backplate or mounting base that had been removed from a medium size COMMAND utility hook (Type 17001ES, available from 3M Company, St. Paul, Minn.). The opposing first adhesive side of the test sample (ink passivated or structured adhesive side) was gently placed on the test substrate with the test substrate horizontally positioned. A load was then attached to the backplate or mounting base of the test sample to simulate finger pressure (100, 200, or 300 gram weights). The test sample was then pulled along the surface of the substrate at a speed of 12 in/min (30.48 cm/min). The pulling force was averaged by the instrument and reported as the force required to slide the sample. Tests were carried out at controlled temperature and humidity conditions of 72° F. (22° C.) and 50% relative humidity. The Shear Strength data in the Tables are an average of 2-3 tests.

Repositionability 1

A test method for quantifying initial repositionability was developed using an INSTRON (Instron Model number 5944 Load Cell 225 lbs). Samples were tested on drywall panels painted with Sherwin-Williams DURATION, Interior Acrylic Latex Ben Bone as described above, at various weights to simulate typical finger pressure that would be incurred when repositioning. Repositionability 1 was measured by recording the max force (oz) required to remove the construction (hook, backplate, adhesive strip) without incurring damage to the pained drywall panel. Test samples were cut into ⅝ in×2 in (1.6 cm×5.1 cm) strips. The second adhesive side of the test sample (the side lacking engineered elements) was first applied to the backplate or mounting base of the COMMAND utility hook (type 17001ES, available from 3M Company, St. Paul, Minn.). The opposing first adhesive side of the test sample (side including engineered elements) was then lightly applied to the test substrate. A load (2-14 lbs) was then applied for 10 seconds to the backplate or mounting base of the test sample to simulate repositioning force. After a hook was attached to the backplate, the test sample was then removed at 90 in/min from the drywall panel via the INSTRON. The max force was reported and recorded. Tests were carried out at controlled temperature and humidity conditions of 72° F. (22° C.) and 50% relative humidity. The Repositionability 1 data in the Tables are an average of 2-3 tests.

Repositionable 2/Repositionable Holding

A test method for quantifying repositionability and subsequent holding power was performed using medium size COMMAND utility hooks (type 17001ES, available from 3M Company, St. Paul, Minn.).

Samples were tested on drywall panels painted with Sherwin-Williams DURATION, Interior Acrylic Latex Ben Bone as described above. Test samples were cut into ⅝ in×2 in (1.6 cm×5.1 cm) strips. The second adhesive side of the test sample (i.e., the side lacking engineered elements) was first applied to the backplate or mounting base of the COMMAND utility hook. The opposing first adhesive side of the test sample (i.e., the side including engineered elements) was then lightly applied to the test substrate. A load was then applied for 10 seconds to the backplate or mounting base of the test sample to simulate a moderate repositioning force (6 lbs). A hook was then attached to the backplate and the sample was removed from the drywall panel by hand. The construction was then lightly placed back in the same position on the drywall panel. After removal of the hook, a 10 lbs load was then applied for 30 seconds to the backplate or mounting base of the test sample to assure proper wet-out of the adhesive to the substrate (10 lbs). The samples were mounted in a vertical position and allowed to dwell on the test substrate for 60 minutes at controlled temperature and humidity conditions of 72° F. (22° C.) and 50% relative humidity before attaching a load to the test sample (0 or 3 lbs weights). Samples were hung until failure or until 30 days had elapsed. Failure was indicated when it was observed that hook article completely fell off the test substrate (the adhesive no longer adhered to the test substrate surface). The Repositionability method 2 data in the Tables is provided as Weight Holding Power (days). The data are an average of 3 tests.

### Examples 1-28

Ink-Passivation Release Liners

A conventional flexographic printing press (available from Retroflex, Inc., Wrightstown, Wis.) was used to apply discontinuous coatings of ink onto a release liner. The flexographic printing deck was set up such that a 6-inch Reverse Angle Doctor Blade System (available from Retroflex, Inc., Wrightstown, Wis.) was installed on the line. Anilox rolls of 12 or 24 BCM (billion cubic microns)/in² and 120 LPI (lines per inch), (fabricated and engraved by Interflex Laser Engravers, Green Bay, Wis.) were used to transfer a specific volume of ink onto the raised features of a print plate. A Dupont DPR 0.067-inch-thick print plate with various dot sizes and area coverages (Imaged and developed via SGS Inc.) was used. The ink was subsequently transferred from the print plate onto a paper liner web having a silicone release surface (Loparex 2040, Loparex, Inc., Cary, N.C.). The ink materials used were a solvent-based red ink (product name SP-400 Y/S RED:D901, available from Sun Chemical, Carlstadt, N.J., with 4% fumed silica added to it) (Ink A), or a UV curable ink (9300 Series UV Flexo Ink, No. 9385 Fluorescent Red, available from Nazdar Ink Technologies, Shawnee, Kans.) (Ink B). An LED curing unit was placed approximately 24 in above the print deck for UV curing (at conditions (35% Power) Gel unit 40 Volts, 13 Amps).

Ink-passivation release liners were prepared having seven different dot patterns, 16, 169, and 1600 dots per inch (DPI) at 10% surface area coverage, and 10, 15, 30, 45, and 51% surface area coverage at 169 DPI.

Adhesive Transfer Tape

An adhesive transfer tape was prepared by knife-coating a pressure-sensitive adhesive composition onto a paper liner web having a silicone release surface (Product no. 2040, Loparex, Inc., Cary, N.C.). The pressure sensitive adhesive used was like the stretch release adhesive composition E-27 in PCT Patent Publication No. WO 2015/195602. In a typical procedure, the adhesive was coated at 43% solids in toluene, with the knife wet gap set so that the dry adhesive coating thickness was approximately 2.75±0.2 mils after drying the coated samples in an oven at 158° F. (70° C.) for 10 minutes. The dry coating thickness of the adhesive was 2.75±0.2 mils.

Ink-Passivated Adhesive Articles

The adhesive transfer tape was adhered to a first side of a composite film-foam-film backing like that found on 3M COMMAND adhesive strip products (31 mil 6 lb. foam with 1.8 mil polyethylene film on both sides of the foam), and the construction was laminated together using a conventional 2 roll laminator. The release liner was removed from the adhesive transfer tape, and the adhesive tape/foam construction was then laid down onto an ink-passivation release liner and the construction was laminated together. The processing conditions for both lamination steps consisted of two passes with the roll pressure set to approximately 25 psi and a line speed of 30 in/min. The same adhesive transfer tape was laminated to the second opposite side of the composite film-foam-film backing using the lamination conditions described above, to provide a double-sided adhesive article where the adhesive on one side of the foam backing (first side) had an outer surface with adhesive regions that were passivated, or deadened, by a discontinuous ink coating. Test samples were then die cut into 2 in×⅝ in (5.1 cm×1.6 cm) strips for Package Weight Claim and Sliding testing, or 0.5 in×0.5 in (1.3 cm×1.3 cm) squares for Shear Strength testing. The release liners were removed from the adhesive article as needed prior to testing.

Ink-passivated adhesive articles were prepared to examine the effect of printed dot pattern resolution (16, 169, and 1600 dots per inch, DPI) at 10% surface area coverage. The printed dot patterns used for adhesive article Examples 1-12 are summarized in Table 1. A Control adhesive article (no ink-passivation) was included for comparison.

TABLE 1
Printed ink dot patterns used for
adhesive article Examples 1-12

| | | Surface | | Anilox | |
|---|---|---|---|---|---|
| | | Area | | Roll | Line |
| | Resolution | Coverage | Ink | Volume | Speed |
| Example | (DPI) | (%) | Type | (BCM/in²) | (ft/min) |
| Control | N/A | N/A | N/A | N/A | N/A |
| 1 | 16 | 10 | A | 12 | 75 |
| 2 | 169 | 10 | A | 12 | 75 |
| 3 | 1600 | 10 | A | 12 | 75 |
| 4 | 16 | 10 | A | 24 | 50 |
| 5 | 169 | 10 | A | 24 | 50 |
| 6 | 1600 | 10 | A | 24 | 50 |
| 7 | 16 | 10 | B | 12 | 100 |
| 8 | 169 | 10 | B | 12 | 100 |
| 9 | 1600 | 10 | B | 12 | 100 |
| 10 | 16 | 10 | B | 24 | 100 |
| 11 | 169 | 10 | B | 24 | 100 |
| 12 | 1600 | 10 | B | 24 | 100 |

TABLE 2
Package Weight Claim test results
for ink-passivated adhesive
on painted drywall test substrate

| | | Weight Holding |
|---|---|---|
| | Weight | Power (days) |
| Example | (lbs) | “Behr PPU FEN” |
| Control | 3 | 30 |
| Control | 6 | >30 |
| 1 | 3 | >30 |
| 1 | 6 | >30 |
| 2 | 3 | 29 |
| 2 | 6 | >30 |
| 3 | 3 | 28 |
| 3 | 6 | >30 |
| 4 | 3 | >30 |
| 4 | 6 | >30 |
| 5 | 3 | 29 |
| 5 | 6 | >30 |
| 6 | 3 | 30 |
| 6 | 6 | >30 |
| 7 | 3 | >30 |
| 7 | 6 | >30 |
| 8 | 3 | >30 |
| 8 | 6 | >30 |
| 9 | 3 | >30 |
| 9 | 6 | >30 |
| 10 | 3 | >30 |
| 10 | 6 | >30 |
| 11 | 3 | >30 |
| 11 | 6 | >30 |
| 12 | 3 | 25 |
| 12 | 6 | >30 |

TABLE 3
Shear Strength test results
for ink-passivated adhesive
on glass test substrate

| | Shear Strength |
|---|---|
| | (minutes) |
| Example | Glass |
| Control | >25000 |
| 1 | >25000 |
| 2 | >25000 |
| 3 | >25000 |
| 4 | >25000 |
| 5 | 22527 |
| 6 | >25000 |
| 7 | 24543 |
| 8 | >25000 |
| 9 | >25000 |

TABLE 4
Sliding test results for ink-passivated adhesive on
painted drywall and glass test substrates

| | Weight | Sliding Force (oz) | Sliding Force |
|---|---|---|---|
| Example | (grams) | “SW Ben Bone” | (oz) Glass |
| Control | 0 | 1.21 ± 0.06 | Did not slide |
| Control | 100 | 10.98 ± 1.43 | Did not slide |
| Control | 200 | 18.84 ± 1.57 | Did not slide |
| Control | 300 | 24.06 ± 1.52 | Did not slide |
| 1 | 0 | 0.38 ± 0.25 | Did not slide |
| 1 | 100 | Not tested | Did not slide |
| 1 | 200 | Not tested | Did not slide |
| 1 | 300 | 27.35 ± 0.16 | Did not slide |
| 2 | 0 | 0.25 ± 0.04 | Did not slide |
| 2 | 100 | Not tested | Did not slide |
| 2 | 200 | Not tested | Did not slide |
| 2 | 300 | 25.13 ± 1.41 | Did not slide |
| 3 | 0 | 0.22 ± 0.04 | Did not slide |
| 3 | 100 | Not tested | Did not slide |
| 3 | 200 | Not tested | Did not slide |
| 3 | 300 | 26.72 ± 0.68 | Did not slide |
| 4 | 0 | 0.22 ± 0.01 | Did not slide |
| 4 | 100 | Not tested | Did not slide |
| 4 | 200 | Not tested | Did not slide |
| 4 | 300 | 23.06 ± 3.54 | Did not slide |
| 5 | 0 | 0.27 ± 0.09 | Did not slide |
| 5 | 100 | Not tested | Did not slide |
| 5 | 200 | Not tested | Did not slide |
| 5 | 300 | 23.79 ± 1.12 | Did not slide |
| 6 | 0 | 0.22 ± 0.21 | 1.90 ± 0.30 |
| 6 | 100 | Not tested | 16.52 ± 0.99 |
| 6 | 200 | Not tested | 33.41 ± 2.40 |
| 6 | 300 | 22.03 ± 0.70 | 41.30 ± 0.22 |
| 7 | 0 | 0.30 ± 0.10 | Did not slide |
| 7 | 100 | Not tested | Did not slide |
| 7 | 200 | Not tested | Did not slide |
| 7 | 300 | 28.39 ± 1.64 | Did not slide |
| 8 | 0 | 0.37 ± 0.13 | Did not slide |
| 8 | 100 | Not tested | Did not slide |
| 8 | 200 | Not tested | Did not slide |
| 8 | 300 | 24.47 ± 7.13 | Did not slide |
| 9 | 0 | 0.21 ± 0.02 | Did not slide |
| 9 | 100 | Not tested | Did not slide |
| 9 | 200 | Not tested | Did not slide |
| 9 | 300 | 25.54 ± 0.66 | Did not slide |
| 10 | 0 | 0.28 ± 0.10 | Did not slide |
| 10 | 100 | Not tested | Did not slide |
| 10 | 200 | Not tested | Did not slide |
| 10 | 300 | 28.42 ± 1.14 | Did not slide |
| 11 | 0 | 0.58 ± 0.28 | Did not slide |
| 11 | 100 | Not tested | Did not slide |
| 11 | 200 | Not tested | Did not slide |
| 11 | 300 | 27.14 ± 0.58 | Did not slide |
| 12 | 0 | 0.24 ± 0.09 | 1.28 ± 0.43 |
| 12 | 100 | Not tested | 12.82 ± 0.00 |
| 12 | 200 | Not tested | Did not slide |
| 12 | 300 | 24.27 ± 0.90 | Did not slide |

Ink-passivated adhesive articles were prepared to examine printed dot patterns having different % surface area coverage (10, 15, 30, 45, and 51%) with a printed dot pattern resolution of 169 DPI. The printed dot patterns for adhesive article Examples 13-28 are summarized in Table 5. The printed dot patterns for adhesive article Examples 2, 5, 8, and 11 are included in the Table as part of this study. A Control adhesive article (no ink-passivation) was included for comparison.

TABLE 5
Printed ink dot patterns used for
adhesive article Examples 13-28

| | | Surface | | Anilox | |
|---|---|---|---|---|---|
| | | Area | | Roll | Line |
| | Resolution | Coverage | Ink | Volume | Speed |
| Example | (DPI) | (%) | Type | (BCM/in²) | (ft/min) |
| Control | N/A | N/A | N/A | N/A | N/A |
| 2 | 169 | 10 | A | 12 | 75 |
| 13 | 169 | 15 | A | 12 | 75 |
| 14 | 169 | 30 | A | 12 | 75 |
| 15 | 169 | 45 | A | 12 | 75 |
| 16 | 169 | 51 | A | 12 | 75 |
| 5 | 169 | 10 | A | 24 | 50 |
| 17 | 169 | 15 | A | 24 | 50 |
| 18 | 169 | 30 | A | 24 | 50 |
| 19 | 169 | 45 | A | 24 | 50 |
| 20 | 169 | 51 | A | 24 | 50 |
| 8 | 169 | 10 | B | 12 | 100 |
| 21 | 169 | 15 | B | 12 | 100 |
| 22 | 169 | 30 | B | 12 | 100 |
| 23 | 169 | 45 | B | 12 | 100 |
| 24 | 169 | 51 | B | 12 | 100 |
| 11 | 169 | 10 | B | 24 | 100 |
| 25 | 169 | 15 | B | 24 | 100 |
| 26 | 169 | 30 | B | 24 | 100 |
| 27 | 169 | 45 | B | 24 | 100 |
| 28 | 169 | 51 | B | 24 | 100 |

TABLE 6
Package Weight Claim test results
for ink-passivated adhesive
on painted drywall test substrate

| | | Weight Holding |
|---|---|---|
| | Weight | Power (days) |
| Example | (lbs) | “Behr PPU FEN” |
| Control | 3 | >30 |
| Control | 6 | >30 |
| 2 | 3 | 29 |
| 2 | 6 | >30 |
| 13 | 3 | 25 |
| 13 | 6 | >30 |
| 14 | 3 | >30 |
| 14 | 6 | >30 |
| 15 | 3 | >30 |
| 15 | 6 | >30 |
| 16 | 3 | >30 |
| 16 | 6 | >30 |
| 5 | 3 | 29 |
| 5 | 6 | >30 |
| 17 | 3 | >30 |
| 17 | 6 | >30 |
| 18 | 3 | 28 |
| 18 | 6 | >30 |
| 19 | 3 | >30 |
| 19 | 6 | >30 |
| 20 | 3 | >30 |
| 20 | 6 | >30 |
| 8 | 3 | >30 |
| 8 | 6 | >30 |
| 21 | 3 | >30 |
| 21 | 6 | >30 |
| 22 | 3 | >30 |
| 22 | 6 | >30 |
| 23 | 3 | >30 |
| 23 | 6 | >30 |
| 24 | 3 | >30 |
| 24 | 6 | >30 |
| 11 | 3 | >30 |
| 11 | 6 | >30 |
| 25 | 3 | >30 |
| 25 | 6 | >30 |
| 26 | 3 | >30 |
| 26 | 6 | >30 |
| 27 | 3 | >30 |
| 27 | 6 | >30 |
| 28 | 3 | >30 |
| 28 | 6 | >30 |

TABLE 7
Shear Strength test results
for ink-passivated adhesive
on glass test substrate

| | Shear Strength |
|---|---|
| | (minutes) |
| Example | Glass |
| Control | >25000 |
| 2 | >25000 |
| 13 | 25000 |
| 14 | 16515 |
| 15 | 11878 |
| 16 | 11592 |
| 5 | 22527 |
| 17 | >25000 |
| 18 | 19360 |
| 19 | 8131 |
| 20 | 7055 |
| 8 | >25000 |
| 21 | >25000 |
| 22 | 24126 |
| 23 | 24017 |
| 24 | >25000 |

TABLE 8
Sliding test results for ink-passivated adhesive
on painted drywall and glass test substrates

| | Weight | Sliding Force (oz) | Sliding Force |
|---|---|---|---|
| Example | (grams) | “SW Ben Bone” | (oz) Glass |
| Control | 0 | 1.21 ± 0.06 | Did not slide |
| Control | 100 | 10.98 ± 1.43 | Did not slide |
| Control | 200 | 18.84 ± 1.57 | Did not slide |
| Control | 300 | 24.06 ± 1.52 | Did not slide |
| 2 | 0 | 0.25 ± 0.04 | Did not slide |
| 2 | 100 | Not tested | Did not slide |
| 2 | 200 | Not tested | Did not slide |
| 2 | 300 | 25.13 ± 1.41 | Did not slide |
| 2 | 0 | 0.33 ± 0.01 | Did not slide |
| 13 | 100 | Not tested | Did not slide |
| 13 | 200 | Not tested | Did not slide |
| 13 | 300 | 25.63 ± 0.95 | Did not slide |
| 14 | 0 | 0.20 ± 0.06 | Did not slide |
| 14 | 100 | Not tested | Did not slide |
| 14 | 200 | Not tested | Did not slide |
| 14 | 300 | 23.23 ± 0.12 | Did not slide |
| 15 | 0 | 0.24 ± 0.02 | Did not slide |
| 15 | 100 | Not tested | 17.31 ± 0.16 |
| 15 | 200 | Not tested | Not tested |
| 15 | 300 | 20.78 ± 0.37 | 47.03 ± 0.00 |
| 16 | 0 | 0.18 ± 0.02 | 2.06 ± 0.25 |
| 16 | 100 | Not tested | Did not slide |
| 16 | 200 | Not tested | Did not slide |
| 16 | 300 | 18.75 ± 0.01 | Did not slide |
| 5 | 0 | 0.26 ± 0.09 | Did not slide |
| 5 | 100 | Not tested | Did not slide |
| 5 | 200 | Not tested | Did not slide |
| 5 | 300 | 22.62 ± 1.12 | Did not slide |
| 17 | 0 | 0.08 ± 0.01 | Did not slide |
| 17 | 100 | Not tested | Did not slide |
| 17 | 200 | Not tested | Did not slide |
| 17 | 300 | 21.35 ± 1.07 | Did not slide |
| 18 | 0 | 0.17 ± 0.06 | Did not slide |
| 18 | 100 | Not tested | Did not slide |
| 18 | 200 | Not tested | Did not slide |
| 18 | 300 | 19.35 ± 0.03 | Did not slide |
| 19 | 0 | 0.10 ± 0.01 | 1.83 ± 0.25 |
| 19 | 100 | Not tested | 16.62 ± 2.19 |
| 19 | 200 | Not tested | Not tested |
| 19 | 300 | 17.09 ± 0.90 | 42.07 ± 2.96 |
| 20 | 0 | 0.11 ± 0.01 | 1.96 ± 0.76 |
| 20 | 100 | Not tested | 15.78 ± 2.10 |
| 20 | 200 | Not tested | Not tested |
| 20 | 300 | 15.53 ± 0.00 | 41.70 ± 5.15 |
| 8 | 0 | 0.37 ± 0.13 | Did not slide |
| 8 | 100 | Not tested | Did not slide |
| 8 | 200 | Not tested | Did not slide |
| 8 | 300 | 24.47 ± 7.10 | Did not slide |
| 21 | 0 | 0.50 ± 0.05 | Did not slide |
| 21 | 100 | Not tested | Did not slide |
| 21 | 200 | Not tested | Did not slide |
| 21 | 300 | 26.97 ± 0.66 | Did not slide |
| 22 | 0 | 0.47 ± 0.35 | Did not slide |
| 22 | 100 | Not tested | Did not slide |
| 22 | 200 | Not tested | Did not slide |
| 22 | 300 | 24.08 ± 1.29 | Did not slide |
| 23 | 0 | 0.19 ± 0.05 | Did not slide |
| 23 | 100 | Not tested | Did not slide |
| 23 | 200 | Not tested | Did not slide |
| 23 | 300 | 22.70 ± 0.77 | Did not slide |
| 24 | 0 | 0.16 ± 0.01 | Did not slide |
| 24 | 100 | Not tested | Did not slide |
| 24 | 200 | Not tested | Did not slide |
| 24 | 300 | 22.01 ± 0.65 | Did not slide |
| 11 | 0 | 0.58 ± 0.28 | Did not slide |
| 11 | 100 | Not tested | Did not slide |
| 11 | 200 | Not tested | Did not slide |
| 11 | 300 | 27.14 ± 0.58 | Did not slide |
| 25 | 0 | 0.23 ± 0.11 | Did not slide |
| 25 | 100 | Not tested | Did not slide |
| 25 | 200 | Not tested | Did not slide |
| 25 | 300 | 26.22 ± 0.15 | Did not slide |
| 26 | 0 | 0.23 ± 0.00 | Did not slide |
| 26 | 100 | Not tested | Did not slide |
| 26 | 200 | Not tested | Did not slide |
| 26 | 300 | 23.65 ± 1.81 | Did not slide |
| 27 | 0 | 0.20 ± 0.01 | 2.47 ± 0.58 |
| 27 | 100 | Not tested | Did not slide |
| 27 | 200 | Not tested | Did not slide |
| 27 | 300 | 21.27 ± 0.21 | Did not slide |
| 28 | 0 | 0.28 ± 0.03 | 1.93 ± 0.35 |
| 28 | 100 | Not tested | 22.14 ± 4.48 |
| 28 | 200 | Not tested | 33.94 ± 3.35 |
| 28 | 300 | 19.96 ± 0.45 | 45.16 ± 0.00 |

### Examples 29-35

Structured Release Liners

Particle filled, embossed release liners were used, as described in U.S. Pat. No. 5,296,277 (Wilson et al.) and U.S. Pat. No. 6,197,397 (Sher et al.). The release liners used were polyethylene coated papers with silicone release coatings. The embossed patterns of the release liners used for adhesive article Examples 29-35 are summarized in Table 9. The patterns produced microreplicated (structured) adhesive surfaces having pegs, or a combination of both pegs and microchannels.

TABLE 9
Embossed release liner patterns for adhesive article Examples 29-35
Embossed release liner patterns

| | Example | | | | | | |
|---|---|---|---|---|---|---|---|
| | 29 | 30 | 31 | 32 | 33 | 34 | 35 |
| Depressions | 7225 | 16900 | 10968 | 10968 | 11612 | 28900 | 22114 |
| per inch² | | | | | | | |
| (Pegs) | | | | | | | |
| Lines per | 85 | 130 | 105* | 105* | 108* | 164 | 148* |
| inch (LPI) | | | | | | | |
| (Pegs) | | | | | | | |
| Peg height | 12 | 12 | 12 | 12 | 12 | 12 | 12 |
| (microns) | | | | | | | |
| Peg tip | 55 | 55 | 55 | 55 | 55 | 79 | 79 |
| diameter | | | | | | | |
| (microns) | | | | | | | |
| Pitch | 300 | 195 | 195** | 195** | 195** | 155 | 155** |
| (between | | | | | | | |
| pegs) | | | | | | | |
| (microns) | | | | | | | |
| Lines per | NA | NA | 75 | 75 | 64 | NA | 64 |
| inch (LPI) | | | | | | | |
| (Channels) | | | | | | | |
| Channel | NA | NA | 25 | 25 | 13.5 | NA | 13.5 |
| depth | | | | | | | |
| (microns) | | | | | | | |
| Channel | NA | NA | 50 | 50 | 40 | NA | 40 |
| width | | | | | | | |
| (microns) | | | | | | | |
| Planar | 3 | 6 | 6 | 6 | 6 | 17 | 17 |
| Surface | | | | | | | |
| Area of | | | | | | | |
| Adhesive | | | | | | | |
| Structures | | | | | | | |
| (%)*** | | | | | | | |
| Adhesive | Pegs | Pegs | Pegs and | Pegs and | Pegs and | Pegs | Pegs and |
| Structures | | | Vertical | Horizontal | Vertical and | | Vertical and |
| | | | Micro-channels | Micro-channels | Horizontal | | Horizontal |
| | | | | | Micro-channels | | Micro-channels |
| | | | | | (Cross Hatch) | | (Cross Hatch) |

*The LPI for samples having both pegs and channels is more an effective or average value due to some overlap of the two patterns
**Pitch does not account for surface irregularities due to channels
***Theoretical surface area not including surface irregularities due to process variations

Adhesive Transfer Tape

An adhesive transfer tape was prepared by knife-coating a pressure-sensitive adhesive composition onto a paper liner web having a silicone release surface (Product no. 2040, Loparex, Inc., Cary, N.C.). The pressure sensitive adhesive used was like the stretch release adhesive composition E-27 in PCT Patent Publication No. WO 2015/195602. In a typical procedure, the adhesive was coated at 43% solids in toluene, with the knife wet gap set so that the dry adhesive coating thickness was approximately 2.75±0.2 mils after drying the coated samples in an oven at 158° F. (70° C.) for 10 minutes. The dry coating thickness of the adhesive was 2.75±0.2 mils.

Structured Adhesive Articles

An adhesive transfer tape as described above was adhered to a first side of a composite film-foam-film backing like that found on 3M COMMAND brand adhesive strip products (31 mil 6 lb. foam with 1.8 mil polyethylene film on both sides of the foam), and the construction was laminated together using a conventional 2 roll laminator. The release liner was removed from the adhesive transfer tape, and the adhesive tape/foam construction was then laid down onto a structured release liner and the construction was laminated together. The processing conditions for both lamination steps consisted of two passes with the roll pressure set to approximately 25 psi and a line speed of 30 in/min. The same adhesive transfer tape was laminated to the second side of the composite film-foam-film backing using the lamination conditions described above, to provide a double-sided adhesive article where the adhesive on one side of the foam backing (first side) had a structured outer surface. Test samples were then die cut into 2 in×⅝ in (5.1 cm×1.6 cm) strips for Package Weight Claim and Sliding testing, or 0.5 in×0.5 in (1.3 cm×1.3 cm) squares for Shear Strength testing. The release liners were removed from the adhesive article as needed prior to testing. A Control adhesive article (lacking a structured liner) was included for comparison.

TABLE 10
Package Weight Claim test results for structured
adhesive on painted drywall and glass test substrates

| | | Weight | Weight | |
|---|---|---|---|---|
| | | Holding | Holding | |
| | | Power | Power | Weight |
| | | (days) | (days) | Holding |
| | | “Behr | “Behr | Power |
| | Weight | PPU | MARQUEE | (days) |
| Example | (lbs) | FEN” | DR” | Glass |
| Control | 3 | >30 | >30 | Not tested |
| Control | 6 | >30 | 29 | >30 |
| Control | 9 | >30 | 29 | Not tested |
| 29 | 3 | >30 | Not tested | Not tested |
| 29 | 6 | >30 | Not tested | Not tested |
| 29 | 9 | >30 | Not tested | Not tested |
| 30 | 3 | >30 | >30 | Not tested |
| 30 | 6 | >30 | >30 | 30 |
| 30 | 9 | 27 | 14 | Not tested |
| 31 | 3 | >30 | >30 | Not tested |
| 31 | 6 | >30 | 30 | 27 |
| 31 | 9 | 23 | 11 | Not tested |
| 32 | 3 | >30 | >30 | Not tested |
| 32 | 6 | 28 | >30 | 28 |
| 32 | 9 | 18 | 9 | Not tested |
| 33 | 3 | >30 | >30 | Not tested |
| 33 | 6 | >30 | 29 | 29 |
| 33 | 9 | 20 | 15 | Not tested |
| 34 | 3 | >30 | Not tested | 25 |
| 34 | 6 | >30 | Not tested | 25 |
| 34 | 9 | Not tested | Not tested | Not tested |
| 35 | 3 | >30 | Not tested | 29 |
| 35 | 6 | >30 | Not tested | 29 |
| 35 | 9 | Not tested | Not tested | Not tested |

TABLE 11
Shear Strength test results for
structured adhesive on painted
drywall and glass test substrates

| | | Shear Strength |
|---|---|---|
| Example | Test Substrate | (minutes) |
| Control | “Behr PPU FEN” | >25,000 |
| Control | “Behr MARQUEE DR” | 23,580 |
| Control | Glass | 16,599 |
| 29 | “Behr PPU FEN” | >25,000 |
| 30 | “Behr PPU FEN” | >25,000 |
| 30 | “Behr MARQUEE DR” | 20,551 |
| 30 | Glass | 24,211 |
| 31 | “Behr PPU FEN” | >25,000 |
| 31 | “Behr MARQUEE DR” | >25,000 |
| 31 | Glass | >25,000 |
| 32 | “Behr PPU FEN” | >25,000 |
| 32 | “Behr MARQUEE DR” | 20,551 |
| 32 | Glass | >25,000 |
| 33 | “Behr PPU FEN” | 17,748 |
| 33 | “Behr MARQUEE DR” | 15,922 |
| 33 | Glass | 21,500 |
| 34 | “Behr PPU FEN” | >25,000 |
| 34 | Glass | 18,569 |
| 35 | “Behr PPU FEN” | 24,463 |
| 35 | Glass | >25,000 |

TABLE 12
Sliding test results for structured adhesive
on painted drywall and glass test substrates

| | Weight | Sliding Force (oz) | Sliding Force |
|---|---|---|---|
| Example | (grams) | “SW Ben Bone” | (oz) Glass |
| Control | 0 | 1.50 ± 0.10 | Did not slide |
| Control | 100 | 12.63 ± 0.77 | Did not slide |
| Control | 200 | 17.40 ± 4.75 | Did not slide |
| Control | 300 | 25.12 ± 4.45 | Did not slide |
| 29 | 0 | 0.32 ± 0.01 | 1.91 ± 0.40 |
| 29 | 100 | 7.82 ± 0.47 | Did not slide |
| 29 | 200 | 13.86 ± 0.70 | Did not slide |
| 29 | 300 | 20.66 ± 4.75 | Did not slide |
| 30 | 0 | Not tested | 0.95 ± 0.80 |
| 30 | 100 | 9.57 ± 0.63 | 19.97 ± 1.76 |
| 30 | 200 | Not tested | 33.69 ± 7.03 |
| 30 | 300 | 28.41 ± 1.27 | Did not slide |
| 31 | 0 | Not tested | Not tested |
| 31 | 100 | Not tested | Not tested |
| 31 | 200 | Not tested | Not tested |
| 31 | 300 | Not tested | Not tested |
| 32 | 0 | Not tested | Not tested |
| 32 | 100 | Not tested | Not tested |
| 32 | 200 | Not tested | Not tested |
| 32 | 300 | Not tested | Not tested |
| 33 | 0 | Not tested | 0.83 ± 0.88 |
| 33 | 100 | 9.1 ± 0.13 | 22.71 ± 2.81 |
| 33 | 200 | Not tested | Did not slide |
| 33 | 300 | 28.04 ± 0.27 | Did not slide |
| 34 | 0 | 0.29 ± 0.03 | 0.47 ± 0.16 |
| 34 | 100 | 8.53 ± 2.16 | 9.96 ± 1.91 |
| 34 | 200 | 13.99 ± 0.94 | Not tested |
| 34 | 300 | 22.28 ± 1.09 | 35.78 ± 5.02 |
| 35 | 0 | 0.42 ± 0.01 | 0.61 ± 0.54 |
| 35 | 100 | Not tested | 2.75 ± 1.29 |
| 35 | 200 | 11.22 ± 1.69 | 7.24 ± 6.13 |
| 35 | 300 | 14.87 ± 2.39 | 6.31 ± 0.91 |

### Repositionability

### Examples 36-51

Ink-passivated adhesive articles were prepared as above to examine the effect of printed dot pattern resolution (1600, 2025 dots per inch square, DPI) and surface area (15, 18, 21, 24) on repositionability and mounting performance. The printed dot patterns used for adhesive article Examples 36-51 are summarized in Table 13. Ink B was the same as above, while Ink C was a UV curable ink (9300 Series UV Flexo Ink, No. 9385 Fluorescent Red, available from Nazdar Ink Technologies, Shawnee, Kans.,) with 4% fumed silica added to it. A Control adhesive article (no ink-passivation) was included for comparison.

TABLE 13
Printed ink dot patterns used for
adhesive article Examples 36-51

| | | | | Anilox | |
|---|---|---|---|---|---|
| | | | | Roll | Line |
| | Resolution | Surface | Ink | Volume | Speed |
| Example | (DPI) | area | Type | (BCM/in2) | (ft/min) |
| 36 | 2025 | 15 | B | 24 | 100 |
| 37 | 2025 | 18 | B | 24 | 100 |
| 38 | 2025 | 21 | B | 24 | 100 |
| 39 | 2025 | 24 | B | 24 | 100 |
| 40 | 1600 | 15 | B | 24 | 100 |
| 41 | 1600 | 18 | B | 24 | 100 |
| 42 | 1600 | 21 | B | 24 | 100 |
| 43 | 1600 | 24 | B | 24 | 100 |
| 44 | 2025 | 15 | C | 24 | 100 |
| 45 | 2025 | 18 | C | 24 | 100 |
| 46 | 2025 | 21 | C | 24 | 100 |
| 47 | 2025 | 24 | C | 24 | 100 |
| 48 | 1600 | 15 | C | 24 | 100 |
| 49 | 1600 | 18 | C | 24 | 100 |
| 50 | 1600 | 21 | C | 24 | 100 |
| 51 | 1600 | 24 | C | 24 | 100 |

TABLE 14
Package Weight Claim test results
for ink-passivated adhesive
articles on painted drywall

| | | Weight | Weight |
|---|---|---|---|
| | | Holding | Holding |
| | | Power | Power |
| | Weight | (Days) | (Days) |
| Example | (lb) | Behr PPU FEN | Glass |
| Control | 3 | >30 | >30 |
| Control | 6 | >30 | >30 |
| 36 | 3 | >30 | >30 |
| 36 | 6 | >30 | >30 |
| 37 | 3 | >30 | >30 |
| 37 | 6 | >30 | >30 |
| 38 | 3 | >30 | >30 |
| 38 | 6 | >30 | >30 |
| 39 | 3 | >30 | >30 |
| 39 | 6 | >30 | >30 |
| 40 | 3 | >30 | >30 |
| 40 | 6 | >30 | >30 |
| 41 | 3 | >30 | >30 |
| 41 | 6 | >30 | >30 |
| 42 | 3 | >30 | >30 |
| 42 | 6 | >30 | >30 |
| 43 | 3 | >30 | >30 |
| 43 | 6 | >30 | >30 |
| 44 | 3 | >30 | >30 |
| 44 | 6 | >30 | >30 |
| 45 | 3 | >30 | >30 |
| 45 | 6 | >30 | >30 |
| 46 | 3 | >30 | >30 |
| 46 | 6 | >30 | >30 |
| 47 | 3 | >30 | >30 |
| 47 | 6 | >30 | >30 |
| 48 | 3 | >30 | >30 |
| 48 | 6 | >30 | >30 |
| 49 | 3 | >30 | >30 |
| 49 | 6 | >30 | >30 |
| 50 | 3 | >30 | >30 |
| 50 | 6 | >30 | >30 |
| 51 | 3 | >30 | >30 |
| 51 | 6 | >30 | >30 |

TABLE 15
Shear Strength test results for
ink-passivated adhesive on
glass test substrate

| | Shear | Shear |
|---|---|---|
| | Strength (min) | Strength |
| Example | Behr PPU FEN | (min) Glass |
| Control | >25000 | >25000 |
| 36 | >25000 | >25000 |
| 37 | >25000 | >25000 |
| 38 | >25000 | >25000 |
| 39 | >25000 | >25000 |
| 40 | >25000 | >25000 |
| 41 | >25000 | >25000 |
| 42 | >25000 | >25000 |
| 43 | >25000 | >25000 |
| 44 | 16696 | >25000 |
| 45 | 8474 | >25000 |
| 46 | >25000 | >25000 |
| 47 | >25000 | >25000 |
| 48 | >25000 | >25000 |
| 49 | >25000 | >25000 |
| 50 | >25000 | >25000 |
| 51 | >25000 | >25000 |

TABLE 16
Repositionability 1 test results
for ink-passivated adhesive
on glass test substrate

| | Mounting | Max | Damage |
|---|---|---|---|
| Example | Weight | load | Status |
| 0 (Ctrl) | 2 | 82.75 | None |
| 0 (Ctrl) | 4 | 162.91 | Backplate tab broken |
| 36 | 6 | 80.97 | None |
| 36 | 8 | 93.03 | None |
| 36 | 10 | 132.28 | Backplate tab broken |
| 39 | 6 | 32.62 | None |
| 39 | 8 | 78.81 | None |
| 39 | 10 | 103.38 | None |
| 39 | 12 | 141.79 | Paint bubble |
| 40 | 6 | 97.14 | None |
| 40 | 8 | 171.91 | Backplate Tab broken/ |
| | | | Paint Bubble |
| 43 | 6 | 55.89 | None |
| 43 | 8 | 102.22 | Paint bubble |
| 43 | 10 | 164.65 | None |
| 43 | 12 | 147.67 | None |
| 44 | 6 | 74.49 | None |
| 44 | 8 | 116.56 | None |
| 44 | 10 | 181.36 | None |
| 44 | 12 | 172.89 | Backplate tab broken |
| 47 | 6 | 58.06 | None |
| 47 | 8 | 68.29 | None |
| 47 | 10 | 93.79 | None |
| 47 | 12 | 162.19 | Paint bubble |
| 47 | 14 | 147.09 | None |
| 47 | 18 | 213.26 | Backplate Tab broken/ |
| | | | Paint Bubble |
| 48 | 6 | 87.72 | None |
| 48 | 8 | 110.01 | None |
| 48 | 10 | 170.87 | Backplate Tab broken |
| 51 | 6 | 50.11 | None |
| 51 | 8 | 85.93 | None |
| 51 | 10 | 126.69 | Backplate tab broken/ |
| | | | Paint Bubble |
| 51 | 12 | 145.51 | Backplate Tab broken |

TABLE 17
Repositionable Holding test
results for ink-passivated
adhesive on glass test substrate

| | | Weight |
|---|---|---|
| | Hanging | Holding |
| | Weight | Power (Days) |
| Example | (lbs) | On BenBone |
| Control | 0 | >30 |
| Control | 3 | >30 |
| 38 | 0 | >30 |
| 38 | 3 | >30 |
| 39 | 0 | >30 |
| 39 | 3 | >30 |
| 40 | 0 | >30 |
| 40 | 3 | >30 |
| 43 | 0 | >30 |
| 43 | 3 | >30 |

The control was not subject to the repositioning part of this test, but only holding weight.

### Examples 52-55

Structured Adhesive Articles

Additional structured adhesive articles were prepared as in the above Examples 29-35. The embossed patterns of the release liners used for adhesive article Examples 52-55 are summarized in Table 18. The patterns produced structured adhesive surfaces having pegs, or a combination of both pegs and microchannels. Test samples were die cut into 2 in×⅝ in (5.1 cm×1.6 cm) strips for Package Weight Claim or 0.5 in×0.5 in (1.3 cm×1.3 cm) squares for Shear Strength testing. The release liners were removed from the adhesive article as needed prior to testing. Structured adhesives possessing the patterns of Examples 29-35 were also subjected to Repositionability 1 testing. A Control adhesive article (lacking a structured liner) was included for comparison.

TABLE 18
Embossed release liner patterns for
adhesive article Examples 52-55

| Example | 52 | 53 | 54 | 55 |
|---|---|---|---|---|
| Depressions | 24862 | 19889 | 19889 | 24862 |
| per inch² (Pegs) | | | | |
| Average lines | 152 | 120* | 120* | 152 |
| per inch (LPI) | | | | |
| (Pegs) | | | | |
| Peg height | 12 | 12 | 12 | 12 |
| (microns) | | | | |
| Peg tip diameter | 55 | 55 | 55 | 70 |
| (microns) | | | | |
| Average pitch | 167 | 167** | 167** | 167** |
| (between pegs) | | | | |
| (microns) | | | | |
| Lines per inch | NA | 75 | 75 | NA |
| (LPI) (Channels) | | | | |
| Channel depth | NA | 25 | 25 | NA |
| (microns) | | | | |
| Channel width | NA | 50 | 50 | NA |
| (microns) | | | | |
| Planar Surface | 9 | 9 | 9 | 14 |
| Area of | | | | |
| Adhesive | | | | |
| Structures | | | | |
| (%) *** | | | | |
| Adhesive | Pegs | Pegs and | Pegs and | Pegs |
| Structures | | Vertical | Horizontal | |
| | | Micro- | Micro- | |
| | | channels | channels | |

*The LPI for samples having both pegs and channels is more an effective or average value due to some overlap of the two patterns
**Pitch does not account for surface irregularities due to channels
*** Theoretical surface area not including surface irregularities due to process variations

TABLE 19
Package Weight Claim test results
for structured adhesive on painted
drywall and glass test substrates

| | | Weight | |
|---|---|---|---|
| | | Holding | Weight |
| | | Power | Holding |
| | | (Days) | Power |
| | Weight | Behr | (Days) |
| Example | (lb) | PPU FEN | Glass |
| Control | 3 | >30 | >30 |
| 52 | 3 | >30 | >30 |
| 53 | 3 | >30 | >30 |
| 54 | 3 | >30 | >30 |
| 55 | 3 | >30 | >30 |

TABLE 20
Shear Strength test results for
structured adhesive on painted
drywall and glass test substrates

| | Shear | Shear |
|---|---|---|
| | Strength (min) | Strength |
| Example | Behr PPU FEN | (min) Glass |
| Control | >25000 | >25000 |
| 36 | >25000 | >25000 |
| 37 | >25000 | >25000 |
| 38 | >25000 | >25000 |
| 39 | >25000 | >25000 |

TABLE 21
Repositionability 1 test results for structure
adhesive on glass test substrate

| | Mounting | | |
|---|---|---|---|
| Example | Weight | Max load | Damage Status |
| Control | 2 | 99.68 | None |
| Control | 4 | 137.92 | Backplate tab broken/ |
| | | | Paint Damage |
| 29 | Did not Test | Did not Test | Did not Test |
| 30 | 1 | 22.80 | None |
| 30 | 2 | 48.26 | None |
| 30 | 3 | 62.22 | None |
| 30 | 4 | 79.26 | Paint Bubbles |
| 30 | 5 | 115.28 | Paint Bubbles |
| 31 | 1 | 40.09 | None |
| 31 | 2 | 62.74 | None |
| 31 | 3 | 83.84 | None |
| 31 | 4 | 90.72 | None |
| 31 | 5 | 125.34 | Paint Bubbles |
| 32 | Did not Test | Did not Test | Did not Test |
| 33 | 1 | 36.39 | None |
| 33 | 2 | 48.90 | None |
| 33 | 3 | 76.84 | None |
| 33 | 4 | 88.29 | None |
| 33 | 5 | 111.42 | None |
| 34 | 1 | 22.64 | None |
| 34 | 3 | 25.35 | None |
| 34 | 4 | 38.24 | None |
| 34 | 5 | 49.12 | None |
| 34 | 10 | 93.96 | None |
| 35 | Did not Test | Did not Test | Did not Test |
| 52 | 6 | 68.92 | None |
| 52 | 8 | 112.95 | None |
| 52 | 10 | 151.24 | None |
| 52 | 12 | 179.33 | Backplate tab broken/ |
| | | | Paint Bubble |
| 53 | 6 | 99.30 | None |
| 53 | 8 | 194.78 | Backplate tab broken |
| 53 | 10 | 179.49 | Backplate tab broken |
| 54 | 6 | 89.62 | Backplate tab broken |
| 54 | 8 | 155.90 | Backplate tab broken |
| 55 | 6 | 34.61 | None |
| 55 | 10 | 80.13 | None |
| 55 | 12 | 123.66 | Paint Bubble |

TABLE 22
Repositionable Holding test
results for structured adhesive
on glass test substrate

| | | Weight |
|---|---|---|
| | Hanging | Holding |
| | Weight | Power (Days) |
| Example | (lbs) | On BenBone |
| Control | 0 | >30 |
| Control | 3 | >30 |
| 52 | 0 | >30 |
| 52 | 3 | >30 |
| 55 | 0 | >30 |
| 55 | 3 | 27 |

### EMBODIMENTS

1. A positionable, stretch releasable adhesive article comprising; a pressure sensitive adhesive layer and defining a first outer surface; and a distribution of engineered surface elements on or partially embedded in the first outer surface, wherein the article has a tensile strength at break sufficiently high so that the article will not rupture prior to being stretched and removed from an adherend at an angle of 35° or less.

2. The adhesive article of embodiment 1, wherein the engineered elements include a deadening layer that minimizes or eliminates the adhesion of the pressure sensitive adhesive.

3. The adhesive article of embodiment 2, wherein the deadening layer has a thickness of between about 0.1 mil and about 10 mils.

4. The adhesive article of any of embodiments 2-3, wherein the deadening layer comprises at least one of a coating, a film, ink, lacquer, and/or a chemical reaction initiated by radiation.

5. The adhesive article of embodiments 1 or 2, wherein the engineered elements define a non-adhesive region.

6. The adhesive article of embodiment 5, wherein the non-adhesive region includes an arranged pattern of non-adhesive elements.

7. The adhesive article of embodiment 6, wherein the first non-adhesive region comprises between about 0.01% and about 80% percent of a total area of the outer surface.

8. The adhesive article of embodiment 7, wherein the first non-adhesive region comprises between about 3% and about 50% percent of the total area of the outer surface.

9. The adhesive article of embodiment 1, wherein the engineered surface elements include substantially spherical synthetic inorganic filler particles.

10. The adhesive article of embodiment 9, wherein inorganic filler particles comprise at least one of glass bubbles, (glass beads) and ceramic microspheres.

11. The adhesive article of embodiment 10, wherein the filler particles are uniformly distributed on the outer surface.

12. The adhesive article of embodiment 10, wherein the filler particles are non-uniformly distributed on the outer surface.

13. The adhesive article of embodiment 11 or 12, wherein the distribution of filler particles defines a non-adhesive region, and wherein the first non-adhesive region comprises between about 50% and about 99% percent of a total area of the outer surface.

14. The adhesive article of embodiment 13, wherein the first non-adhesive region comprises between about 70% and about 95% percent of the total area of the outer surface.

15. The adhesive article of embodiment 1, wherein the engineered surface elements comprise a plurality of pegs protruding outwardly from the adhesive layer, wherein the pegs have essentially flat tops that comprise less than 25% of the total surface contact area of the adhesive layer and the planar adhesive surface contiguous with the base and between the pegs is greater than 30% of the total adhesive layer.

16. The adhesive article of embodiment 15, wherein the pegs comprise adhesive and one or more beads encompassed in the adhesive.

17. The adhesive article of embodiment 15 or 16, wherein the beads are organic or inorganic particles.

18. The adhesive article of embodiment 15, further comprising an embossed liner having a low adhesion surface and depressions in which some or all the pegs are located.

19. The adhesive article of any of the preceding embodiments, wherein the adhesive article removes from an adherend damage-free.

20. The adhesive article of any of the preceding embodiments, wherein the adhesive article exhibits a shear strength of greater than 10,000 minutes as measured according to ASTM D3654-82.

21. The adhesive article of any of the preceding embodiments, wherein the adhesive article exhibits a shear strength of greater than 25,000 minutes as measured according to ASTM D3654-82.

22. The adhesive article of any of the preceding embodiments, wherein the adhesive article exhibits a stretch debond force between about 20 and about 170 oz/0.625 inch.

23. The adhesive article of any of the preceding embodiments, wherein the article has a tensile strength at break sufficiently high so that the article will not rupture prior to being stretched and removed from an adherend at an angle of 35° or less.

24. The adhesive article of any of the preceding embodiments, wherein the pressure sensitive adhesive includes at least one of hydrocarbon block copolymers, silicone block copolymers, and combinations thereof.

25. The adhesive article of any of embodiments 1-23, wherein the adhesive includes at least one of SBS, SBR, SIS, SEBS, acrylate, and/or polyurethane.

26. The adhesive article of any of the preceding embodiments, wherein the adhesive includes at least one of the following tackifiers: polyterpene, terpene phenol, rosin esters, hydrocarbons, C5 resins, C9 resins, and/or rosin acids.

27. The adhesive article of any of the preceding embodiments, and further including a mounting device coupled to the second major surface of the backing.

28. The adhesive article of embodiment 27, wherein the mounting device is at least one of a hook, clip, magnet, detachable mechanical fastener, snap, loop, or detachable mechanical fastener.

29. The adhesive article of embodiment 1, and wherein the article includes a backing, and wherein the pressure sensitive adhesive layer is disposed on the backing.

30. The adhesive article of embodiment 29, wherein the backing comprises at least one of a film, a foam, a nonwoven, and combinations thereof.

31. The adhesive article of any of the previous embodiments, and further comprising a plurality of channels on the first outer surface, and wherein the channels define exit pathways that provide a fluid egress.

32. The adhesive article of embodiment 31, wherein the channels define land structures, and wherein an exposed major surface of the land structures includes one of more engineered surface elements.

33. The adhesive article of embodiment 31, wherein the average distance between adjacent channels in said pattern is up to 400 μm.

34. The adhesive article of embodiment 31, wherein said channels have an aspect ratio in the range of about 0.1 to about 20

35. The adhesive article of embodiment 31, wherein said channels define exit pathways that provide a fluid egress to a periphery of said article.

36. The adhesive article of embodiment 31, wherein the article is at least one of positionable and repositionable.

37. The adhesive article of embodiment 36, wherein the article is repositionable.

38. A positionable, stretch releasable adhesive article comprising; a pressure sensitive adhesive layer and defining a first outer surface; and a distribution of engineered surface elements on, within, or partially embedded in the first outer surface, wherein the article has a tensile strength at break sufficiently high so that the article will not rupture prior to being stretched and removed from an adherend at an angle of 35° or less,
wherein the engineered surface elements include intrusive features defining one or more land regions, and wherein the land regions include protrusive engineered elements.

39. The adhesive article of embodiment 38, wherein the intrusive features comprise a plurality of channels, and wherein the protrusive features comprise pegs.

40. The adhesive article of embodiment 39, wherein the channels do not intersect over the first outer surface.

41. The adhesive article of embodiment 39, wherein each channel of the plurality of channels is in communication with at least one other channel.

42. The adhesive article of embodiment 40, wherein the article is removable from an adherend when pulled along a debond axis and wherein the channels are oriented parallel to the debond axis.

43. The adhesive article of embodiment 40, wherein the article is removable from an adherend when pulled along a debond axis, and wherein the channels are oriented perpendicular to the debond axis.

44. The adhesive article of embodiment 41, wherein the article is removable from an adherend when pulled along a debond axis, and wherein the channels are arranged in a cross-hatch array oriented at an angle relative to the debond axis.

45. The adhesive article of embodiment 44, wherein the channels include a first series of channels oriented at an acute angle relative to the debond axis, and a second series of channels oriented substantially orthogonal to the first series.

46. The adhesive article of embodiment 41, wherein the article is removable from an adherend when pulled along a debond axis, and wherein the channels are arranged in a cross-hatch array with a first series of channels oriented parallel to the debond axis and a second series of channels oriented perpendicular to the debond axis.

47. The adhesive article of embodiment 39, wherein the pegs have essentially flat tops that comprise less than 25% of the total surface contact area of the adhesive layer and a planar adhesive surface contiguous with the base and between the pegs is greater than 30% of the total adhesive layer.

48. The adhesive article of embodiment 47, wherein the pegs comprise adhesive and one or more beads encompassed in the adhesive.

49. The adhesive article of embodiments 38-48, wherein the article is at least one of positionable and repositionable.

50. The adhesive article of embodiment 49, wherein the article is repositionable.

51. A method for securing a stretch-release adhesive article to a mounting surface, the method comprising providing the article of any of the embodiments 1-50; adhering the article to the mounting surface at a first location on the mounting surface; moving the article to a second location on the mounting surface remote from the first location; and adhering the article to the mounting surface at the second location.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

We claim:

1. A positionable, stretch releasable adhesive article comprising;
a pressure sensitive adhesive layer and defining a first outer surface; and a distribution of engineered surface elements on or partially embedded in the first outer surface, wherein the article has a tensile strength at break sufficiently high so that the article will not rupture prior to being stretched and removed from an adherend at an angle of 35° or less, wherein the article is at least one of positionable and repositionable.

2. The adhesive article of claim 1, wherein the engineered elements include a deadening layer that minimizes or eliminates the adhesion of the pressure sensitive adhesive, wherein the deadening layer comprises at least one of a coating, a film, ink, lacquer, and/or a chemical reaction initiated by radiation.

3. The adhesive article of claim 2, wherein the deadening layer has a thickness of between about 0.1 mil and about 10 mils.

4. (canceled)

5. The adhesive article of claim 1, wherein the engineered elements define a non-adhesive region, and wherein the non-adhesive region includes an arranged pattern or distribution of non-adhesive elements.

6. The adhesive article of claim 5, wherein the first non-adhesive region comprises between about 3% and about 50% percent of a total surface contact area of the adhesive layer.

7. The adhesive article of claim 1, wherein the engineered surface elements comprise a plurality of pegs protruding outwardly from the adhesive layer, wherein the pegs have essentially flat tops that comprise less than 25% of a total surface contact area of the adhesive layer.

8. The adhesive article of claim 7, wherein the pegs comprise adhesive and one or more beads encompassed in the adhesive.

9. The adhesive article of claim 8, further comprising an embossed liner having a low adhesion surface and depressions in which some or all the pegs are located.

10-14. (canceled)

15. The adhesive article of claim 1, and further comprising a plurality of channels on the first outer surface, and wherein the channels define exit pathways that provide a fluid egress.

16. The adhesive article of claim 15, wherein the channels define land structures, and wherein an exposed major surface of the land structures includes one of more engineered surface elements.

17. The adhesive article of claim 15, wherein the average distance between adjacent channels in said pattern is up to 400 μm.

18. The adhesive article of claim 15, wherein said channels have an aspect ratio in the range of about 0.1 to about 20.

19-20. (canceled)

21. A positionable, stretch releasable adhesive article comprising;
a pressure sensitive adhesive layer and defining a first outer surface; and a distribution of engineered surface elements on, within, or partially embedded in the first outer surface, wherein the article has a tensile strength at break sufficiently high so that the article will not rupture prior to being stretched and removed from an adherend at an angle of 35° or less,
wherein the engineered surface elements include intrusive features defining one or more land regions, and wherein the land regions include protrusive engineered elements.

22. The adhesive article of claim 21, wherein the intrusive features comprise a plurality of channels, and wherein the protrusive features comprise pegs.

23. The adhesive article of claim 21, wherein the channels do not intersect over the first outer surface.

24. The adhesive article of claim 21, wherein each channel of the plurality of channels is in communication with at least one other channel.

25. The adhesive article of claim 21, wherein the article is removable from an adherend when pulled along a debond axis and wherein the channels are oriented parallel to the debond axis, the channels are oriented perpendicular to the debond axis, or both.

26. The adhesive article of claim 21, wherein the article is removable from an adherend when pulled along a debond axis, and wherein the channels include a first series of channels oriented at an acute angle relative to the debond axis, and a second series of channels oriented substantially orthogonal to the first series.

27. (canceled)

28. A method for securing a stretch-release adhesive article to a mounting surface, the method comprising:
providing the article including a pressure sensitive adhesive layer and a first outer surface; and a distribution of engineered surface elements on or partially embedded in the first outer surface, wherein the article has a tensile strength at break sufficiently high so that the article will not rupture prior to being stretched and removed from an adherend at an angle of 35° or less;
adhering the article to the mounting surface at a first location on the mounting surface;
moving the article to a second location on the mounting surface remote from the first location;
and adhering the article to the mounting surface at the second location.

29. The method of claim 28, wherein moving the article to a second location comprises sliding the article across the mounting surface or removing the article from the surface without stretching.

30. (canceled)
